(19) United States
(12) Patent Application Publication
(10) Pub. No.: US 2026/0089659 A1
(43) Pub. Date: Mar. 26, 2026

(54) COMMUNICATION METHODS FOR SYNCHRONIZATION, AND NETWORK DEVICE

(71) Applicant: GUANGDONG OPPO MOBILE TELECOMMUNICATIONS CORP., LTD., Dongguan (CN)

(72) Inventors: Jinyu ZHANG, Dongguan (CN); Weijie XU, Dongguan (CN); Shengjiang CUI, Dongguan (CN); Ke WANG, Dongguan (CN)

(21) Appl. No.: 19/410,018

(22) Filed: Dec. 5, 2025

Related U.S. Application Data
(63) Continuation of application No. PCT/CN2023/111829, filed on Aug. 8, 2023.

(51) Int. Cl. H04W 56/00; H04L 5/00

(52) U.S. Cl. CPC H04W 56/0015; H04L 5/0051

(57) ABSTRACT

Provided is a communication method for synchronization. The method is applicable to zero-power communication and performed by a network device, and includes: transmitting a reference signal, wherein the reference signal is used for time-domain synchronization and frequency-domain synchronization of a zero-power device, and the reference signal includes at least one sequence group, wherein the at least one sequence group is formed based on a synchronization sequence repeated N times, N being an integer greater than or equal to 1.

### CROSS-REFERENCE TO RELATED APPLICATION

This application is a continuation application of international application No. PCT/CN2023/111829, filed on Aug. 8, 2023, the entire contents of which are incorporated herein by reference.

### TECHNICAL FIELD

The present disclosure relates to the field of zero-power, and in particular, relates to communication methods for synchronization, and a network device.

### RELATED ART

Radio frequency (RF) and baseband circuits of a zero-power device are simple in design. The zero-power device uses a low-power oscillator that is easier to implement to reduce complexity and reduce power consumption.

### SUMMARY

The present disclosure provides communication methods for synchronization, and a network device. The technical solutions are as follows.

According to some embodiments of the present disclosure, a communication method for synchronization is provided. The method is applicable to zero-power communication and performed by a network device, and includes:
transmitting a reference signal, wherein the reference signal is used for time-domain synchronization and frequency-domain synchronization of a zero-power device, and
the reference signal includes at least one sequence group, wherein the at least one sequence group is formed based on a synchronization sequence repeated N times, N being an integer greater than or equal to 1.

According to some embodiments of the present disclosure, a communication method for synchronization is provided. The method is applicable to zero-power communication and performed by a zero-power device, and includes:
receiving a reference signal, wherein the reference signal is used for time-domain synchronization and frequency-domain synchronization of the zero-power device, and
the reference signal includes at least one sequence group, wherein the at least one sequence group is formed based on a synchronization sequence repeated N times, N being an integer greater than or equal to 1.

According to some embodiments of the present disclosure, a network device is provided. The network device includes:
a processor;
a transmitter connected to the processor; and
a memory, configured to store one or more executable instructions of the processor,
wherein the transmitter is configured to transmit a reference signal, wherein the reference signal is used for time-domain synchronization and frequency-domain synchronization of a zero-power device, and
the reference signal includes at least one sequence group, wherein the at least one sequence group is formed based on a synchronization sequence repeated N times, N being an integer greater than or equal to 1.

### BRIEF DESCRIPTION OF DRAWINGS

To describe the technical solutions according to the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of a zero-power communication system according to some exemplary embodiments of the present disclosure;

FIG. 2 is a schematic diagram of RF power harvesting in some practices;

FIG. 3 is a schematic diagram of a backscattering communication process in some practices;

FIG. 4 is a schematic diagram of resistive load modulation in some practices;

FIG. 5 is a schematic diagram of an encoding mode in some practices;

FIG. 6 is a schematic flowchart of a communication method for synchronization according to some exemplary embodiments of the present disclosure;

FIG. 7 is a schematic flowchart of a communication method for synchronization according to some exemplary embodiments of the present disclosure;

FIG. 8 is a schematic diagram of a first synchronization sequence according to some exemplary embodiments of the present disclosure;

FIG. 9 is a schematic diagram of a third synchronization sequence according to some exemplary embodiments of the present disclosure;

FIG. 10 is a schematic diagram of a third synchronization sequence according to some exemplary embodiments of the present disclosure;

FIG. 11 is a schematic diagram of a third synchronization sequence according to some exemplary embodiments of the present disclosure;

FIG. 12 is a schematic diagram of a third synchronization sequence according to some exemplary embodiments of the present disclosure;

FIG. 13 is a schematic diagram of a third synchronization sequence according to some exemplary embodiments of the present disclosure;

FIG. 14 is a schematic diagram of a third synchronization sequence according to some exemplary embodiments of the present disclosure;

FIG. 15 is a schematic diagram of randomization processing according to some exemplary embodiments of the present disclosure;

FIG. 16 is a schematic diagram of randomization processing according to some exemplary embodiments of the present disclosure;

FIG. 17 is a schematic diagram of randomization processing according to some exemplary embodiments of the present disclosure;

FIG. 18 is a schematic flowchart of a communication method for synchronization according to some exemplary embodiments of the present disclosure;

FIG. 19 is a schematic flowchart of a communication method for synchronization according to some exemplary embodiments of the present disclosure;

FIG. 20 is a schematic diagram of a second synchronization sequence according to some exemplary embodiments of the present disclosure;

FIG. 21 is a structural block diagram of a communication apparatus for synchronization according to some exemplary embodiments of the present disclosure;

FIG. 22 is a structural block diagram of a communication apparatus for synchronization according to some exemplary embodiments of the present disclosure; and

FIG. 23 is a schematic structural diagram of a communication device according to some exemplary embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. The exemplary embodiments are described in detail herein, and examples are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to limit the present disclosure. As used in the present disclosure and the appended claims, the singular forms “a,” “an,” and “the” are intended to include the plural forms as well, unless the context clearly indicates otherwise. It should also be understood that the term “and/or” as used herein refers to and encompasses any or all possible combinations of one or more associated listed items.

It should be understood that although the terms “first,” “second,” “third,” and the like may be used herein to describe various pieces of information, and such information should not be limited to these terms. These terms are only used to distinguish one type of information from another. For example, first information may also be referred to as second information, and similarly, second information is also referred to as first information, without departing from the scope of the present disclosure. The word “if,” as used herein, may be interpreted as “in a case where,” “in a case when,” or “in response to determining that,” depending on the context.

First of all, the communication techniques involved in the embodiments of the present disclosure are introduced.

### 1. Brief Introduction of Zero-Power Communication

The zero-power device is implemented based on zero-power Internet of things (IoT), which is also referred to as an ambient power enabled IoT (ambient IoT/A-IoT) or passive IoT.

A terminal device adopting the communication technique is referred to as an Ambient IoT device/A-IoT device. The zero-power IoT device uses various environmental energies such as RF energy, optical energy, solar energy, thermal energy, and mechanical energy to drive the zero-power IoT device itself. The zero-power IoT device may have no energy storage capability or only have a limited energy storage capability (e.g., using a capacitor with a capacity of tens of microfarads). Compared with other IoT devices, the zero-power IoT devices have many advantages, for example, the zero-power IoT devices are conventional battery-free, maintenance-free, small in size, low in complexity, low in cost, and have a long service life.

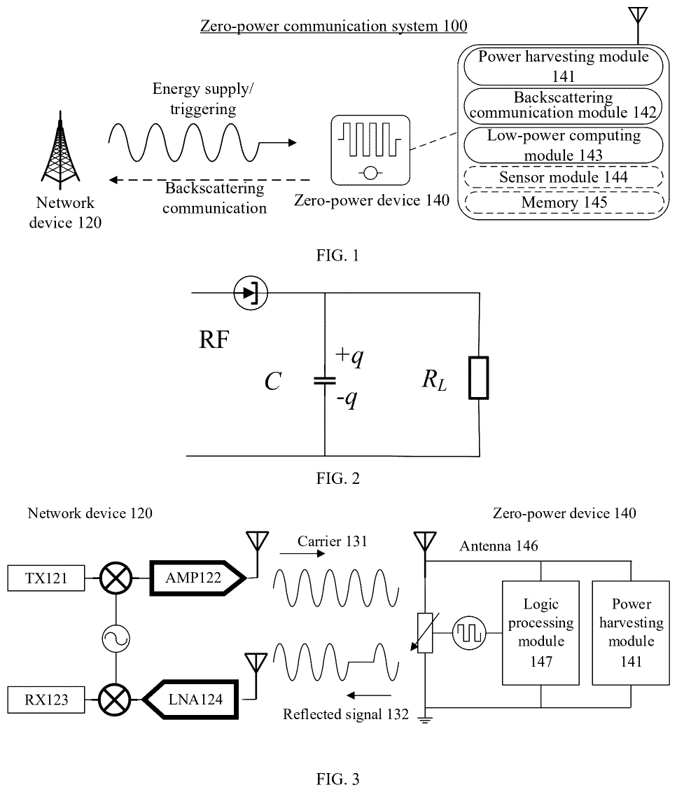

FIG. 1 illustrates a schematic diagram of a zero-power communication system 100 according to some embodiments of the present disclosure. The zero-power communication system 100 includes a network device 120 and a zero-power device 140.

The network device 120 is used to transmit a wireless energy supply signal and a downlink communication signal to the zero-power device 140 and receive a backscattering signal from the zero-power device 140. The zero-power terminal 140 includes an energy harvesting module 141, a backscattering communication module 142, and a low-power computing module 143. The energy harvesting module 141 harvests energy carried by radio waves in space for driving the low-power computing module 143 of the zero-power device 140 and implementing backscattering communication. Upon acquiring the energy, the zero-power device 140 receives control signaling from the network device 120 and transmits data to the network device 120 by backscattering based on the control signaling. The transmitted data may be from data stored in the zero-power device 140 (e.g., identity or pre-written information, such as production date, brand, and manufacturer).

The zero-power device 140 further includes a sensor module 144 and a memory 145. The sensor module 144 includes various sensors. The zero-power device 140 reports, based on a zero-power mechanism, data collected by the various sensors. The memory 145 is used to store some basic information (such as item identifiers) or acquire sensing data, such as ambient temperature and ambient humidity.

The zero-power device 140 does not need any battery, and implements simple signal demodulation, decoding or coding, modulation, and other simple operations using the low-power computing module 143. Therefore, a zero-power module only requires a simple hardware design, thereby lowering the cost and reducing the size of the zero-power device 140.

The network device 120 includes, but is not limited to, a cellular network device such as a 5G/6G network device and a base station device, and a Wi-Fi/WLAN network device such as an access point (AP), a router, and a mobile AP. The mobile AP may be a phone.

The zero-power device 140 includes, but is not limited to, a handheld device, a wearable device, an in-vehicle device, an IoT device, or the like. The zero-power device 140 may be at least one of a phone, a tablet computer, an e-book reader, a laptop computer, a desktop computer, a television, a game console, an augmented reality (AR) terminal, a virtual reality (VR) terminal, a mixed reality (MR) terminal, a wearable device, a handle, an electronic tag, a controller, or the like.

The technical solutions according to some embodiments of the present disclosure are applicable to various communication systems, such as a global system of mobile communication (GSM) system, a code-division multiple access (CDMA) system, a wideband code-division multiple access (WCDMA) system, a general packet radio service (GPRS) system, a long-term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a 5th generation (5G) system, a cellular IoT system, a cellular passive IoT system, a future evolved system of a 5G NR system, or 6th generation (6G) system and a future evolved system thereof.

It is understandable that, in the embodiments of the present disclosure, “5G” may also be referred to as “5G NR” or “NR”.

It is understandable that, in the description of the embodiments of the present disclosure, the term “corresponding” may indicate a direct corresponding relationship or an indirect corresponding relationship between two items, or an association relationship between the two items, or a relationship such as indicating and being indicated, configuring and being configured, or the like.

In the embodiments of the present disclosure, the term “predefined” may be implemented by pre-storing a corresponding code, a corresponding table, or another method that may be used to indicate relevant information in a communication device (such as a zero-power device or a network device), and a specific implementation thereof is not limited in the present disclosure. For example, the term “predefined” may be “defined” in a protocol.

### 2. RF Power Harvesting

FIG. 2 is a schematic principle diagram of RF power harvesting. The RF power harvesting is to harvest, based on the principle of electromagnetic induction, spatial electromagnetic wave energy using an RF module by electromagnetic induction and connection to a capacitor C and a load resistor R_{L} that are connected in parallel to acquire energy required to drive the zero-power device to operate, for example, driving a low-power demodulation module, a modulation module, a sensor, and memory reading. Therefore, the zero-power terminal does not need any traditional battery.

### 3. Backscattering Communication

FIG. 3 is a schematic principle diagram of a backscattering communication process. The zero-power terminal 140 receives a wireless signal carrier 131 transmitted by a transmit (TX) module 121 of the network device 120 via an amplifier (AMP) 122, modulates the wireless signal carrier 131, loads the information to be transmitted via a logic processing module 147, and harvests RF energy via the energy harvesting module 141. The zero-power terminal 140 radiates a modulated reflected signal 132 using an antenna 146. This information transmission process is referred to as backscattering communication. A receive (RX) module 123 of the network device 120 receives the modulated reflected signal 132 using a low-noise amplifier (LNA) 124. Backscattering and load modulation functions are inseparable. Load modulation is a process of completing modulation by adjusting and controlling circuit parameters of an oscillation circuit of the zero-power terminal 140 based on rhythms of data streams to cause parameters such as impedance of electronic tags to change accordingly.

The load modulation technology mainly includes resistive load modulation and capacitive load modulation. FIG. 4 is a schematic principle diagram of resistive load modulation. In the resistive load modulation, the load resistor R_{L} is connected in parallel to a third resistor R₃, a switch S is turned on or turned off based on binary-coded control, turn-on or turn-off of the third resistor R₃ may cause a change of voltage on a circuit, the load resistor R_{L} is connected in parallel to a first capacitor C₁, the load resistor R_{L} is connected in series to a second resistor R₂, and the second resistor R₂ is connected in series to a first inductor L₁. The first inductor L₁ is coupled to a second inductor L₂, and the second inductor L₂ is connected in series to a second capacitor C₂. In this way, amplitude shift keying (ASK) may be implemented. That is, signal modulation and signal transmission are implemented by adjusting an amplitude of the backscattering signal from the zero-power terminal. Similarly, in the capacitive load modulation, a resonant frequency of a circuit may be changed based on turn-on or turn-off of a capacitor, such that frequency shift keying (FSK) is implemented. That is, signal modulation and signal transmission are implemented by adjusting an operating frequency of the backscattering signal from the zero-power terminal.

The zero-power terminal carries out information modulation on an incoming signal by load modulation, such that the backscattering communication process is implemented. The zero-power terminal has the following significant advantages: the terminal does not actively transmit any signal, and thus the complex RF link, such as a power amplifier (PA) and an RF filter in the RF link, is not required; the terminal is not required to actively generate any high-frequency signal, and thus a high-frequency crystal oscillator is not required; and the terminal carries out signal transmission by backscattering communication, without consuming energy of the terminal.

### 4. Application Scenarios of Zero-Power Communication

Due to significant advantages such as extremely low cost, extremely low power consumption, and small size, the zero-power communication is widely applicable in various industries, such as logistics, intelligent warehousing, smart agriculture, energy and power, industrial internet, and the like for vertical industries; and is also applicable in personal applications, such as smart wearables and smart home.

For example, the zero-power communication is at least applicable to the following four scenarios.
(1) object identification, such as logistics management, management of production line products, and supply chain management.
(2) Environmental monitoring, such as monitoring of temperature, humidity, and harmful gases in operating environment and natural environment.
(3) Positioning, such as indoor positioning, intelligent object tracking, and positioning of production line items.
(4) Intelligent control, such as intelligent control of various appliances in smart homes (turning on/off air conditioners and adjusting temperature) and intelligent control of various facilities in agricultural greenhouses (automatic irrigation and fertilization).

### 5. a Coding Scheme of Zero-Power Communication

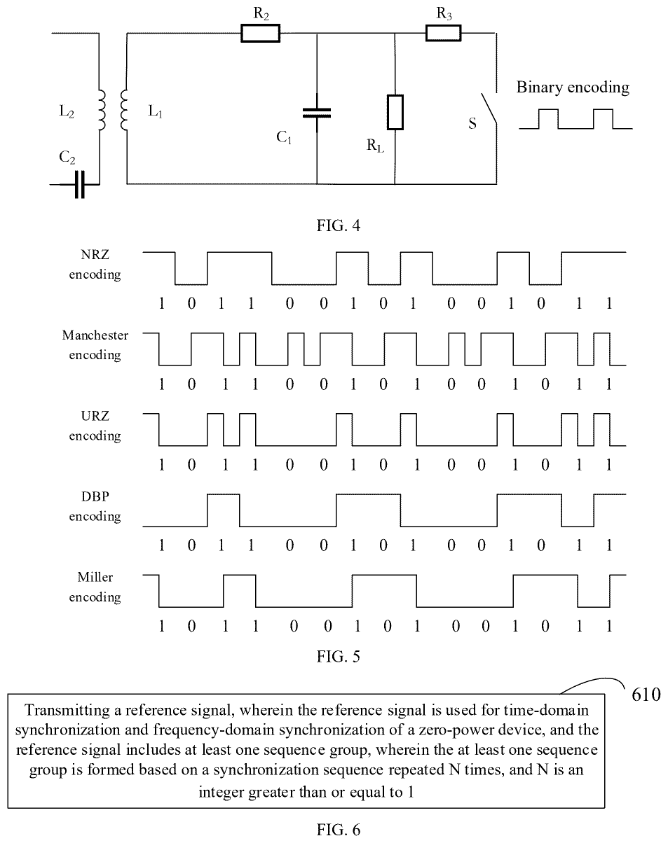

FIG. 5 is a schematic diagram of a coding scheme in zero-power communication. For data transmitted by electronic tags, binary “1” and binary “0” may be represented using different forms of codes. A radio frequency identification (RFID) system generally adopts one of: non-return-to-zero (NRZ) coding, Manchester coding, unipolar return-to-zero (URZ) coding, differential binary phase (DBP) coding, Miller coding, or differential coding. That is, 0 and 1 may be represented using different pulse signals.
In NRZ coding, binary “1” is represented by a high level, and binary “0” is represented by a low level. NRZ coding in FIG. 5 is a schematic diagram of levels of binary data 101100101001011 encoded by NRZ coding.
Manchester coding is also referred to as split-phase coding. In Manchester coding, a binary value is represented by a change (rise or fall) in a level in a half bit cycle within a bit length. A negative transition in a half bit cycle represents binary “1”, and a positive transition in a half bit cycle represents binary “0”. An error in data transmission means that when data bits transmitted by a plurality of electronic tags at the same time have different values, received rising and falling edges offset each other, resulting in an uninterrupted carrier signal throughout the entire bit length. In Manchester coding, it is impossible that a state without a change is present within the bit length. A reader/writer may determine, using the error, a specific location where a collision occurs. Manchester coding helps detect data transmission errors, and the Manchester coding is generally used for data transmission from the electronic tags to the reader/writer when load modulation or backscattering modulation of carriers is adopted. Manchester coding in FIG. 5 is a schematic diagram of levels of binary data 101100101001011 encoded by Manchester coding.
In URZ coding, binary “1” is represented by a high level in a first half bit cycle of URZ coding, and binary “1” is represented by a low-level signal that lasts for an entire bit cycle. URZ coding in FIG. 5 is a schematic diagram of levels of binary data 101100101001011 encoded by URZ coding.
In DBP coding, binary “0” is represented by any edge in a half bit cycle, and binary “1” is represented by no edge. In addition, levels are inverted at the beginning of each bit cycle. It is relatively easy for the receiver to reconstruct a bit beat. DBP coding in FIG. 5 is a schematic diagram of levels of binary data 101100101001011 encoded by DBP coding.
In Miller coding, binary “1” is represented by any edge in a half bit cycle, and binary “0” is represented by a constant level in a next bit cycle. Level alternation occurs at the beginning of a bit cycle. It is relatively easy for the receiver to reconstruct a bit beat. Miller coding in FIG. 5 is a schematic diagram of levels of binary data 101100101001011 encoded by Miller coding.
In differential coding, each binary “1” to be transmitted may cause a change in signal level, while for binary “0”, the signal level remains the same.

It should be noted that the coding schemes are illustrated for the coding scheme in the zero-power communication, and are not intended to limit the present disclosure.

### 6. Types of Zero-Power Devices (Classified Based on Energy Sources and Usage Modes)

### (1) Passive Zero-Power Device

The zero-power device does not need a built-in battery. In a case where the zero-power device is close to a network device, the zero-power device is within a near field range formed by antenna radiation of the network device. In some embodiments, the network device is a reader/writer of the RFID system. Therefore, an antenna of the zero-power device generates an induced current by electromagnetic induction, and the induced current drives a low-power chip circuit of the zero-power device. Demodulation of a forward link signal and modulation of a backward link signal are implemented. For a backscattering link, the zero-power device carries out signal transmission by backscattering or ultra-low-power active transmission. The passive zero-power device does not need a built-in battery to drive either for the forward link or a reverse link, and is a true zero-power device. The passive zero-power device does not need any battery, in which an RF circuit and a baseband circuit are very simple. For example, the passive zero-power device does not need devices such as an LNA, a PA, a crystal oscillator, and an analog-to-digital converter (ADC), and has many advantages such as small size, light weight, very low price, and long service life.

### (2) Semi-Passive Zero-Power Device

The semi-passive zero-power device is not provided with any conventional battery, and may harvest radio wave energy by an RF energy harvesting module, and at the same time, store the harvested energy in an energy storage unit. In some embodiments, the energy storage unit is a capacitor. Upon acquiring the energy, the energy storage unit may drive a low-power chip circuit of the zero-power device. Demodulation of a forward link signal and modulation of a backward link signal are implemented. For a backscattering link, the zero-power device carries out signal transmission by backscattering or ultra-low-power active transmission.

The semi-passive zero-power device does not need any built-in battery to drive either for the forward link or a reverse link, and in operation, uses energy stored in the capacitor that is from radio energy harvested by the RF energy harvesting module, which is a true zero-power device.

The semi-passive zero-power device inherits many advantages of the passive zero-power device, such as small size, light weight, very low price, and long service life.

### (3) Active Zero-Power Device

The zero-power device used in some scenarios is an active zero-power device. The active zero-power device may be provided with a built-in battery. The battery is configured to drive a low-power chip circuit of the zero-power device. Demodulation of a forward link signal and modulation of a backward link signal are implemented. However, for a backscattering link, the zero-power device carries out signal transmission by backscattering or ultra-low-power active transmission. Therefore, zero power of the active zero-power device is mainly reflected in the fact that signal transmission in the reverse link does not consume the power of the zero-power device itself but uses backscattering. In the active zero-power device, the built-in battery supplies power to an RFID chip, and thus a reading/writing distance of a tag is increased and reliability of communication is improved. Therefore, the active zero-power device is applicable to some scenarios where relatively high requirements are put forward for a communication distance and a read latency.

### 7. Types of Zero-Power Devices (Classified Based on the Transmitter)

### (1) Zero-Power Device Based on Backscattering

Such a zero-power device carries out uplink data transmission by backscattering as described above. Such a zero-power device does not have an active transmitter for active transmission but only has a transmitter for backscattering. Therefore, when carrying out uplink data transmission, such a zero-power device needs a network device to provide carriers, and implement backscattering based on the carriers to implement uplink data transmission.

### (2) Zero-Power Device Based on an Active Transmitter

Such a zero-power device has an active transmitter with an active transmission capability for active transmission, and when carrying out uplink data transmission, such a zero-power device can transmit data using its own active transmitter, and does not need a network device to provide carriers. An active transmitter applicable to a zero-power device may be an ultra-low-power ASK transmitter, an ultra-low-power FSK transmitter, or the like. Based on current implementations, the overall power consumption of such transmitters can be reduced to 400 microwatts to 600 microwatts in a case where a 100-microwatt signal is transmitted.

### (3) Zero-Power Device Based on Both Backscattering and an Active Transmitter

Such a zero-power device supports both reverse scattering and an active transmitter. The zero-power device determines whether to perform backscattering or perform active transmission using an active transmitter based on different situations (such as different power levels and different available environment energy sources) or based on the scheduling of a network device.

### 8. A Cellular IoT

The cellular IoT is booming. For example, IoT technologies, such as narrow band-IoT (NB-IoT), machine-type communications (MTC) and RedCap, have been standardized in the 3rd Generation Partnership Project (3GPP). However, the IoT communication needs cannot be met yet in many scenarios.

### Strict Communication Environment

In some IoT scenarios, extreme environment such as high temperature, extremely low temperature, high humidity, high voltage, high radiation, or high-speed movement may occur. Such scenarios include ultra-high voltage transformer substations, high-speed train track monitoring, environmental monitoring in extremely cold regions, industrial production lines, and the like. In these scenarios, existing IoT terminal devices cannot operate due to the operating environment restrictions of conventional power supplies. In addition, extreme operating environment are not conducive to the maintenance of IoT terminal devices, e.g., battery replacement.

### Needs for Ultra-Small Size of Terminals

In some IoT scenarios, such as food traceability, commodity circulation, and smart wearables, a terminal needs to have an ultra-small size for convenient use in these scenarios. For example, an IoT terminal device used for commodity management in a circulation process is usually in the form of an electronic tag, and the IoT terminal device is embedded in commodity packaging in a very compact form. For another example, a lightweight wearable IoT terminal device improve user experience while meeting user needs.

### Needs for Ultra-Low-Cost IoT Communication

In numerous IoT communication scenarios, an IoT terminal devices needs to have sufficiently low cost so as to enhance its competitiveness relative to other alternative techniques. For example, in logistics or warehousing scenarios, to facilitate the management of a large volume of items in circulation, an IoT terminal device is attached to each item, thereby achieving precise management of the entire logistics process and lifecycle by means of the communication between the IoT terminal device and a logistics network. In these scenarios, the IoT terminal device needs to have a very competitive price.

Therefore, to meet these IoT communication needs that have not been met yet, an IoT that has ultra-low cost and an ultra-small size and is battery-free/maintenance-free needs to be developed in the cellular IoT, and the zero-power IoT can perfectly meet these needs.

### 9. Time and Frequency Synchronization

### (1) Time and Frequency Synchronization Mode One

Time and frequency synchronization is performed through a primary synchronization signal (PSS) and a secondary synchronization signal (SSS) in a synchronization signal and physical broadcast channel (PBCH) block (SSB).

The present disclosure exemplarily provides a typical implementation, where a terminal device performs correlation detection of the PSS in the time domain, and acquires clock information (e.g., a start position of an orthogonal frequency-division multiplexing (OFDM) symbol) based on a position of a sequence correlation peak. During the process of correlation detection of the PSS in the time domain, an approximate frequency offset is estimated through blind search (that is, coarse frequency offset estimation is performed). A specific implementation of the coarse frequency offset estimation may involve presetting several fixed frequency offset values (referred to as frequency bins, for example, 0, +/−7.5 kHz, and +/−15 kHz), compensating the frequency offset values to a local sequence (or a received signal), performing correlation detection on the local sequence or the received signal, and comparing magnitudes of correlation peaks with different frequency offset value assumptions. A larger magnitude value indicates that the actual frequency offset value is closer to the corresponding preset frequency offset value, such that the approximate frequency offset is estimated. After the correlation detection of the PSS is performed, a resource position of the SSS signal is determined, and fine frequency offset estimation and calibration are performed in the frequency domain. In this way, the frequency offset error is controlled within a small range and does not affect subsequent data transmission and reception.

### (2) Time and Frequency Synchronization Mode Two

Time and frequency synchronization is performed through a short training sequence (ST) and a long training sequence (LT).

The ST includes ten identical portions each corresponding to 16 sampling points, and is used for frame synchronization, automatic gain control (AGC), antenna selection, and coarse frequency offset estimation. The coarse frequency offset estimation uses the last five portions of the ST. For a coarse frequency offset estimation method, reference is made to Formula (1):

$${\hat{α}}_{ST} = \frac{1}{16} ∠ ( {\sum }_{m = 0}^{63} {S}_{m}^{*} {S}_{m + 16} ) \qquad ( 1 )$$

The LT includes two identical portions and is used for fine frequency offset estimation. First, calibration needs to be performed based on a coarse frequency offset estimation result from the previous process, and fine estimation and calibration are then performed on this basis.

For a fine frequency offset estimation method, reference is made to Formula (2):

$${\hat{α}}_{LT} = \frac{1}{64} ∠ ( {\sum }_{m = 0}^{63} {S}_{m}^{*} {S}_{m + 64} ) \qquad ( 2 )$$

Both Formula (1) and Formula (2) described above estimate the frequency offset based on a phase between sequences repeated in the time domain. The mathematical model is s(m)=x(m)*exp(j*α*m). Since an integer ambiguity is present in the phase calculation process and only a fractional part within [0, 2pi] can be determined, the actual frequency offset estimation accuracy/range is inversely proportional to a distance between the repeated sequences. In the case where the ST is used for the coarse frequency offset estimation and the distance between two repeated sequences is Δ=16, the estimation range is [0, 2pi]/16. In the case where the LT is used for the fine frequency offset estimation and the distance between two repeated sequences is Δ=64, the estimation range is narrowed to [0, 2pi]/64. Assuming that the error/accuracy of the phase angle calculation operation at the same receiver is relatively constant, the larger denominator Δ (from 16 to 64) indicates that the resolution of the frequency offset estimation is higher.

In the embodiments of the present disclosure, the frequency offset estimation accuracy may alternatively be replaced with the frequency offset estimation resolution.

### 10. Wake Up Receiver (WUR)-Synchronization (Sync) Field

The WUR-Sync field is used for time-domain synchronization and indicating a data transmission rate, for example, indicating a high dynamic range (HDR) or a low dynamic range (LDR) for data transmission.

The WUR-Sync field used for indicating the LDR includes one or two identical W sequences. One W sequence corresponds to 32 bits, and each bit corresponds to a multi-carrier on-off keying (MC-OOK) symbol with a length of 2 μs. Exemplarily, the W sequence is illustrated in Formula (3):

$$W = [ 10100100101110110001011100111000 ] \qquad ( 3 )$$

The WUR-Sync field used for indicating the HDR includes a W̅ sequence, and the W̅ sequence is generated by performing a bitwise complement operation on the W sequence. The bitwise complement operation may be understood as inverting the value of each bit. For example, in the case where the value of the first bit in the W sequence is 0, the value of the first bit in the W̅ sequence becomes 1 upon the bitwise complement operation.

Exemplarily, the W̅ sequence is illustrated in Formula (4):

$$\overline{W} = [ 010110110100010011100100011000111 ] \qquad ( 4 )$$

RF and baseband circuits of a zero-power device are very simple. For example, the zero-power device does not require all or part of components such as an LNA, a PA, a crystal oscillator, or an ADC, and thus offers many advantages such as a small size, a low weight, a very low price, a long service life, and a maintenance-free operation.

However, such a design also brings a number of technical challenges. For example, For low device complexity to reduce power consumption of the device, the zero-power device does not use a crystal oscillator as an oscillator thereof, but instead uses a simple oscillator, such as an RC oscillator or an LC oscillator. These oscillators are easy to implement, and consume significantly less power than the crystal oscillator. However, these oscillators have poor clock and frequency accuracy, with a frequency stability, for example, of 200 parts per million (ppm). In the case where the zero-power device operates at 920 MHz, the frequency stability of 200 ppm causes an error of 184 kHz (900 MHz*200*10−6=184 kHz). For example, in the case where the zero-power device operates at 2400 MHz, the frequency stability of 200 ppm causes an error of 480 kHz (2400 MHz*200*10−6=480 kHz). The large frequency offset not only affects subsequent communication operations of the zero-power device, but also causes deviation from a working channel specified by a frequency specification, thereby causing interference to other devices or systems. For example, 20 channels are divided in an industrial, scientific, and medical (ISM) frequency band of 920 MHz to 925 MHz, with each channel having a bandwidth of 250 kHz. Therefore, in the case where the frequency offset error is 184 kHz, the zero-power device is likely to deviate from an accurate working channel, causing errors in signal transmission and reception or causing interference to other devices on adjacent channels.

Therefore, a frequency estimation and calibration solution needs to be designed to ensure, as much as possible, that the A-IoT device operates in an accurate frequency range. The accurate frequency range may be a frequency range configured by the network device for the zero-power device, or may be a frequency range defined by a communication protocol.

Based on the above problems, the present disclosure provides a communication method for synchronization, which supports a zero-power device in performing time and frequency synchronization to ensure, as much as possible, that the zero-power device operates on accurate time domain resources and frequency domain resources.

FIG. 6 is a schematic flowchart of a communication method for synchronization according to some exemplary embodiments of the present disclosure. The method is performed by a network device. The method includes the following process.

In S610, a reference signal is transmitted, wherein the reference signal is used for time-domain synchronization and frequency-domain synchronization of a zero-power device, and the reference signal includes at least one sequence group, wherein the at least one sequence group is formed based on a synchronization sequence repeated N times, and N is an integer greater than or equal to 1.

In some embodiments, at least one of synchronization sequences or values of N corresponding to different sequence groups are different. This is understood as different sequence groups corresponding to different synchronization sequences, or different sequence groups corresponding to different values of N, or different sequence groups corresponding to both different synchronization sequences and different values of N.

The synchronization sequence repeated N times may be understood as (N+1) repeated synchronization sequences (including one synchronization sequence that is repeated and N repeated synchronization sequences). Exemplarily, in the case where the sequence group is formed based on sequence A repeated N times, the sequence group is formed based on (N+1) sequences A, and the (N+1) sequences A are repeated.

In some embodiments, the reference signal includes one sequence group, and the sequence group is formed based on a synchronization sequence repeated at least once.

In some embodiments, the reference signal includes at least two sequence groups, one sequence group is formed based on a synchronization sequence repeated at least once, and the other sequence group is formed based on a synchronization sequence repeated at least once. The synchronization sequences corresponding to different sequence groups are the same or different, and the numbers of repetitions of the synchronization sequences corresponding to different sequence groups are the same or different.

In some embodiments, the reference signal includes at least two sequence groups, one sequence group is formed based on a synchronization sequence (which is not repeated), and the other sequence group is formed based on a synchronization sequence repeated at least once. The synchronization sequences corresponding to different sequence groups are the same or different, and the numbers of repetitions of the synchronization sequences corresponding to different sequence groups are the same or different.

In summary, in the method according to the embodiments of the present disclosure, the reference signal formed based on the synchronization sequence repeated N times is used for time and frequency synchronization, and the reference signal is transmitted by the network device, such that the zero-power device performs time and frequency synchronization based on the reference signal to operate as much as possible on accurate time domain resources and frequency domain resources. In addition, the sequence group in the reference signal, the synchronization sequence, and the number of repetitions of the synchronization sequence are designed independently, such that the flexibility of the reference signal is significantly improved to satisfy the synchronization requirements in different scenarios.

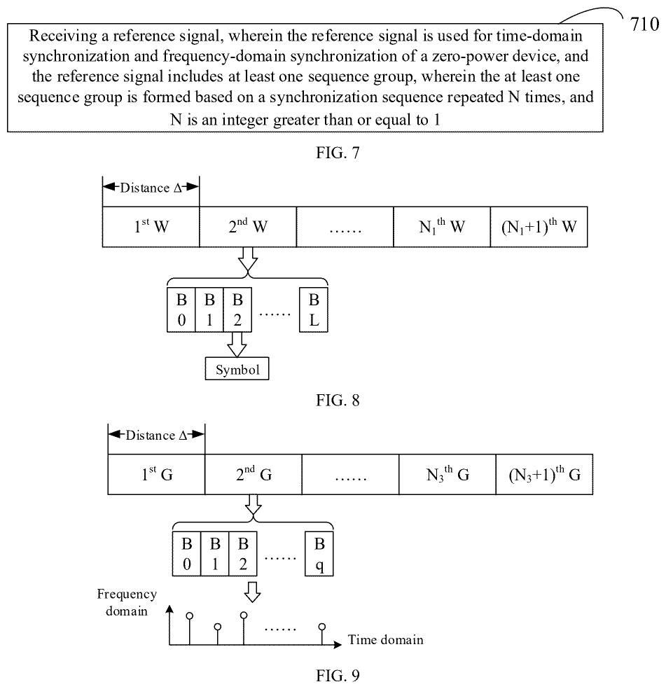

FIG. 7 is a schematic flowchart of a communication method for synchronization according to some exemplary embodiments of the present disclosure. The method is performed by a zero-power device. The method includes the following process.

In S710, a reference signal is received, wherein the reference signal is used for time-domain synchronization and frequency-domain synchronization of the zero-power device, and the reference signal includes at least one sequence group, wherein the at least one sequence group is formed based on a synchronization sequence repeated N times, and N is an integer greater than or equal to 1.

In some embodiments, at least one of synchronization sequences or values of N corresponding to different sequence groups are different. This is understood as different sequence groups corresponding to different synchronization sequences, or different sequence groups corresponding to different values of N, or different sequence groups corresponding to both different synchronization sequences and different values of N.

The synchronization sequence repeated N times may be understood as (N+1) repeated synchronization sequences. Exemplarily, in the case where the sequence group is formed based on sequence A repeated N times, the sequence group is formed based on (N+1) sequences A, and the (N+1) sequences A are repeated.

In some embodiments, the reference signal includes one sequence group, and the sequence group is formed based on a synchronization sequence repeated at least once.

In some embodiments, the reference signal includes at least two sequence groups, one sequence group is formed based on a synchronization sequence repeated at least once, and the other sequence group is formed based on a synchronization sequence repeated at least once. The synchronization sequences corresponding to different sequence groups are the same or different, and the numbers of repetitions of the synchronization sequences corresponding to different sequence groups are the same or different.

In some embodiments, the reference signal includes at least two sequence groups, one sequence group is formed based on a synchronization sequence (which is not repeated), and the other sequence group is formed based on a synchronization sequence repeated at least once. The synchronization sequences corresponding to different sequence groups are the same or different, and the numbers of repetitions of the synchronization sequences corresponding to different sequence groups are the same or different.

In summary, in the method according to the embodiments of the present disclosure, the reference signal formed based on the synchronization sequence repeated N times is used for time and frequency synchronization of the zero-power device, such that the zero-power device operates as much as possible on accurate time domain resources and frequency domain resources. In addition, the sequence group in the reference signal, the synchronization sequence, and the number of repetitions of the synchronization sequence are be designed independently, such that the flexibility of the reference signal is significantly improved to satisfy the synchronization requirements in different scenarios.

The reference signal mentioned in the above embodiments is described in detail hereinafter.

In some embodiments, the sequence group in the reference signal corresponds to at least one bit, which is also understood as a bit length of the sequence group in the reference signal being greater than or equal to 1. In some embodiments, each bit corresponds to at least one time-domain unit, or each bit corresponds to at least one sampling point.

In some embodiments, the sequence group is formed based on at least one of:
a synchronization sequence corresponding to the at least one time-domain unit;
a synchronization sequence corresponding to the at least one sampling point; or
a synchronization sequence corresponding to a portion of one time-domain unit.

In the embodiments of the present disclosure, the time-domain unit includes at least one of a frame, a subframe, a slot, a mini-slot, a subslot, a symbol, a symbol group, or a unit based on another time-domain unit.

The symbol includes at least one of: an OFDM symbol, a quadrature phase shift keying (QPSK) symbol, an amplitude shift keying (ASK) symbol, a frequency shift keying (FSK) symbol, an on-off keying (OOK) symbol, or an MC-OOK symbol.

In some embodiments, parameters of the reference signal satisfy at least one of the following conditions:
being associated with an operating frequency band of the zero-power device;
being associated with a subcarrier spacing; or
being defined by a communication protocol.

The parameters of the reference signal include at least one of a length of the synchronization sequence, a value of N, or a length of each time-domain unit corresponding to the synchronization sequence.

In some embodiments, in addition to being used for time and frequency synchronization of the zero-power device, the reference signal is further used for indicating a transmission rate.

In some embodiments, the reference signal indicates an LDR through the synchronization sequence repeated N times, or indicates an HDR through a bitwise complement sequence of the synchronization sequence.

In some embodiments, the reference signal indicates the LDR through synchronization sequence C with a number of repetitions being a first value, or indicates the HDR through synchronization sequence D with a number of repetitions being a second value. In some embodiments, synchronization sequence C is different from synchronization sequence D. Alternatively, synchronization sequence D is a bitwise complement sequence of synchronization sequence C.

Considering the number of sequence groups in the reference signal, the design of the reference signal includes at least the following two solutions.

### In a First Solution, the Reference Signal Includes One Sequence Group

For descriptive distinction, the sequence group involved in the first solution is referred to as a first sequence group, and the synchronization sequence used for forming the first sequence group is referred to as a first synchronization sequence.

The first sequence group corresponds to at least one bit, that is, a bit length of the first sequence group is greater than or equal to 1. In some embodiments, each bit corresponds to at least one time-domain unit, or each bit corresponds to at least one sampling point.

In some embodiments, the first sequence group is formed based on the first synchronization sequence corresponding to the at least one time-domain unit. That is, the first synchronization sequence corresponding to the at least one time-domain unit is understood as the first synchronization sequence occupying one or more time-domain units in the time domain.

In some embodiments, the first sequence group is formed based on the first synchronization sequence corresponding to the at least one sampling point. That is, the first synchronization sequence corresponding to the at least one sampling point is understood as the first synchronization sequence corresponding to one or more sampling points in the time domain.

In some embodiments, the first sequence group is formed based on the first synchronization sequence corresponding to a portion of a time-domain unit. That is, the first synchronization sequence corresponding to the portion of the time-domain unit is understood as the first synchronization sequence occupying a portion of the time-domain unit in the time domain. In this case, the time-domain unit corresponds to at least two first synchronization sequences.

In some embodiments, the first sequence group is formed based on two or more of the first synchronization sequence corresponding to the at least one time-domain unit, the first synchronization sequence corresponding to the at least one sampling point, or the first synchronization sequence corresponding to the portion of the time-domain unit. Exemplarily, the first sequence group includes the first synchronization sequence corresponding to the at least one time-domain unit, and includes the first synchronization sequence corresponding to the at least one sampling point. Exemplarily, the first sequence group includes the first synchronization sequence corresponding to the portion of the time-domain unit, and includes the first synchronization sequence corresponding to the at least one sampling point.

The first sequence group is formed based on the first synchronization sequence repeated N₁ times, and N₁ is an integer greater than or equal to 1. This may also be understood as the first sequence group being formed based on (N₁+1) repeated first synchronization sequences.

Exemplarily, the first synchronization sequence repeated N₁ times is illustrated in FIG. 8, where the first sequence group corresponds to (N₁+1) repeated first synchronization sequences W, which are separately represented by 1^{st} W, 2^{nd} W, . . . , N₁^{th} W, and (N₁+1)^{th} W.

The first synchronization sequence W corresponds to L bits, where L≥1, and the L bits are separately represented by B0, B1, . . . , and BL.

Each bit corresponds to at least one sampling point, or corresponds to at least one time-domain unit, or corresponds to a portion of a time-domain unit. Using an example where the time-domain unit is a symbol, each bit corresponds to at least one symbol; or each bit corresponds to a portion of a symbol. For example, each bit corresponds to 1/t of the symbol. In FIG. 8, each bit corresponds to a symbol.

In some embodiments, different bits in the L bits correspond to the same number of sampling points or the same number of time-domain units.

In some embodiments, different bits in the L bits correspond to different numbers of sampling points or different numbers of time-domain units. Exemplarily, the first synchronization sequence W corresponds to three bits, the first bit corresponds to one sampling point, the second bit corresponds to three sampling points, and the third bit corresponds to two sampling points. Exemplarily, the first synchronization sequence W corresponds to eight bits, the first four bits correspond to two QPSK symbols, and the last four bits correspond to three QPSK symbols.

It should be noted that “the first sequence group being formed based on the first synchronization sequence repeated N₁ times” means that the following two cases are possible for the formation of the first sequence group:

In one case, the first sequence group includes the first synchronization sequence repeated N₁ times, that is, the (N₁+1) repeated first synchronization sequences form the first sequence group.

In another case, the first sequence group is a randomized sequence group formed based on the first synchronization sequence repeated N₁ times. This may be understood as the first sequence group including sequences acquired by performing randomization processing on the first synchronization sequence repeated N₁ times, that is, the first sequence group formed by performing randomization processing on the (N₁+1) repeated first synchronization sequences. This case takes into account the fact that the repetition of the synchronization sequence may cause the energy of the reference signal to be overly concentrated within the bandwidth, which is detrimental to the robustness of the reference signal. The formed reference signal has a more uniform power distribution upon the randomization processing, which is conducive to the transmission quality and stability of the reference signal.

The randomization processing, also referred to as randomizing processing, and involves multiplying the synchronization sequence by a random sequence or a pseudo-random sequence, which may also be understood as multiplying the synchronization sequence by the random sequence or corresponding sequence elements in the pseudo-random sequence. In the embodiments of the present disclosure, an example in which the synchronization sequence is multiplied by the pseudo-random sequence is used for description. For related content of multiplying the synchronization sequence by the random sequence, reference is made to the following description. The sequence elements in the pseudo-random sequence take at least two values from +1, −1, +j, −j, or the like. Exemplarily, the pseudo-random sequence includes several sequence elements with values of +1 and −1. Exemplarily, the pseudo-random sequence includes several sequence elements with values of +j and −j. Exemplarily, the pseudo-random sequence includes several sequence elements with values of +1, −1, +j, and −j. Exemplarily, the pseudo-random sequence is [+1, −1, +1, −1]. Exemplarily, the pseudo-random sequence is [1+1i, 1−1i, −1+1i, −1−1i].

Considering the granularity of the randomization processing, the following three randomization processing modes for the first synchronization sequence are provided in the embodiments of the present disclosure:

In randomization processing mode one, the first synchronization sequence is in one-to-one correspondence with the sequence elements.

An i^{th} first synchronization sequence in the first synchronization sequence repeated N₁ times is multiplied by an i^{th} sequence element in the pseudo-random sequence. That is, the first sequence group is acquired by multiplying the (N₁+1) repeated first synchronization sequences by (N₁+1) sequence elements.

It is assumed that the pseudo-random sequence C=[C₁, C₂, . . . , C_{X}], where X=(N₁+1).

Then, the first sequence group=[C₁*R(1), C₂*R(2), . . . , C_{X}*R(N₁+1)]. R(i) represents the i^{th} first synchronization sequence in the (N₁+1) repeated first synchronization sequences, and Cᵢ represents the i^{th} sequence element in (N₁+1) pseudo-random sequence elements.

Exemplarily, the first sequence group is formed based on the first synchronization sequence repeated twice, that is, the first sequence group is formed based on three repeated first synchronization sequences.

The first synchronization sequence repeated twice=[R₁, R₂, R₃]. Rᵢ represents the i^{th} first synchronization sequence in the three repeated first synchronization sequences. The pseudo-random sequence C=[C₁, C₂, C₃]. C₁ represents the i^{th} sequence element in the three sequence elements.

Then, the first sequence group=[C₁*R₁, C₂*R₂, C₃*R₃].

Exemplarily, the pseudo-random sequence C=[+1, −1, +1, −1], and the first synchronization sequence=[1, 0, 0, 1]. Assuming that bit 1 in the synchronization sequence corresponds to sampling point 1 in the time domain, bit 0 in the synchronization sequence corresponds to sampling point 0 in the time domain, and the first sequence repeated three times is {[1, 0, 0, 1], [1, 0, 0, 1], [1, 0, 0, 1], [1, 0, 0, 1]}, then the first sequence group={[1, 0, 0, 1], [−1, 0, 0, −1], [1, 0, 0, 1], [−1, 0, 0, −1]}.

Exemplarily, the pseudo-random sequence C=[+1, −1, +1, −1], and the first synchronization sequence=[1, 0, 0, 1]. Assuming that bit 1 in the synchronization sequence corresponds to two sampling points (a1, a2) in the time domain, bit 0 in the synchronization sequence corresponds to two sampling points (b1, b2) in the time domain, then the first sequence group={[a1, a2, b1, b2, b1, b2, a1, a2], [−a1, −a2, −b1, −b2, −b1, −b2, −a1, −a2], [a1, a2, b1, b2, b1, b2, a1, a2], [−a1, −a2, −b1, −b2, −b1, −b2, −a1, −a2]}.

In randomization processing mode two, a first partial sequence in the first synchronization sequence is in one-to-one correspondence with the sequence elements.

In some embodiments, a first synchronization sequence includes at least one first partial sequence. That is, the first synchronization sequence is divided into several portions, and each portion is referred to as a first partial sequence.

It is assumed that the (N₁+1) repeated first synchronization sequences include Y₁ first partial sequences in total. Y₁≥(N₁+1), or Y₁ is an integer multiple of (N₁+1). Then, an i^{th} first partial sequence in the first synchronization sequence repeated N₁ times is multiplied by an i^{th} sequence element in the pseudo-random sequence. That is, the first sequence group is acquired by multiplying the Y₁ first partial sequences by Y₁ sequence elements. It is assumed that the pseudo-random sequence C=[C₁, C₂, . . . , C_{Y}], where Y=Y₁≥(N₁+1).

Then, the first sequence group=[C₁*S(1), C₂*S(2), . . . , C_{Y}*S(Y₁)]. S(i) represents the i^{th} first partial sequence in the (N₁+1) repeated first synchronization sequences, and Cᵢ represents the i^{th} sequence element in Y sequence elements.

It should be noted that the sequence number i refers to a sequence number of the first synchronization sequence in the Y₁ first partial sequences in the first synchronization sequence repeated N₁ times. Exemplarily, the first synchronization sequence is [1, 0, 1], and the first synchronization sequence includes three first partial sequences. Then, the first synchronization sequence repeated once includes 3*2=6 first partial sequences in total. In the case where the sequence number is 2, the sequence number refers to a second first partial sequence in {[1, 0, 1], [1, 0, 1]}(i.e., the second digit from the left, “0”). In the case where the sequence number is 5, the sequence number refers to a fifth first partial sequence in {[1, 0, 1], [1, 0, 1]}(i.e., the fifth digit from the left, “0”).

Exemplarily, the first sequence group is formed based on the first synchronization sequence repeated twice, that is, the first sequence group is formed based on three repeated first synchronization sequences. Each first synchronization sequence corresponds to three symbols. Then, the first synchronization sequence repeated twice corresponds to nine symbols in total. Each first synchronization sequence may be divided into three first partial sequences based on the symbols. Then, the first synchronization sequence repeated twice corresponds to nine first partial sequences in total.

The first synchronization sequence repeated twice=[S₁, S₂, S₃, S₄, S₅, S₆, S₇, S₈, S₉]. Sᵢ represents the i^{th} first partial sequence in the nine first partial sequences, and S₁=S₄=S₇, S₂=S₅=S₈, and S₃=S₆=S₉. The pseudo-random sequence C=[C₁, C₂, C₃, C₄, C₅, C₆, C₇, C₈, C₉]. Cᵢ represents the i^{th} sequence element in the nine sequence elements.

Then, the first sequence group=[C₁*S₁, C₂*S₂, C₃*S₃, C₄*S₄, C₅*S₅, C₆*S₆, C₇*S₇, C₈*S₈, C₉*S₉].

Exemplarily, the pseudo-random sequence=[+1, −1, +1, −1, −1, +1, +1, −1, +1], and the first synchronization sequence=[1, 0, 1]. Then, the first synchronization sequence repeated twice={[1, 0, 1], [1, 0, 1], [1, 0, 1]}, and the first sequence group={[1, 0, 1], [−1, 0, 1], [1, 0, 1]}.

Exemplarily, the pseudo-random sequence C=[+1, −1, +1, −1, −1, +1, +1, −1, +1], and the first synchronization sequence=[1, 0, 1]. Assuming that bit 1 in the synchronization sequence corresponds to two sampling points (a1, a2) in the time domain and, bit 0 in the synchronization sequence corresponds to two sampling points (b1, b2) in the time domain, then the first synchronization sequence repeated twice={[1, 0, 1], [1, 0, 1], [1, 0, 1]}={[a1, a2, b1, b2, a1, a2], [a1, a2, b1, b2, a1, a2], [a1, a2, b1, b2, a1, a2]}. Assuming that the first synchronization sequence includes three first partial sequences and each first partial sequence includes two sampling points corresponding to one bit, that is, one first partial sequence includes the whole (a1, a2) or the whole (b1, b2), then the first sequence group={[a1, a2, −b1, −b2, a1, a2], [−a1, −a2, −b1, −b2, a1, a2], [a1, a2, −b1, −b2, a1, a2]}.

Exemplarily, the pseudo-random sequence C=[+1, −1, +1, −1, −1, +1, +1, −1, +1, +1, −1, −1], and the first synchronization sequence=[1, 0]. Assuming that bit 1 in the synchronization sequence corresponds to two sampling points (a1, a2) in the time domain and bit 0 in the synchronization sequence corresponds to two sampling points (b1, b2) in the time domain, then the first synchronization sequence repeated twice={[1, 0], [1, 0], [1, 0]}={[a1, a2, b1, b2], [a1, a2, b1, b2], [a1, a2, b1, b2]}. Assuming that the first synchronization sequence includes four first partial sequences and each first partial sequence includes one sampling point, that is, one first partial sequence includes a1 or a2 or b1 or b2, then the first sequence group={[a1, −a2, b1, −b2], [−a1, a2, b1, −b2], [a1, a2, −b1, −b2]}.

In randomization processing mode three, a first partial sequence group in the first synchronization sequence is in one-to-one correspondence with the sequence elements.

In some embodiments, a first synchronization sequence includes at least one first partial sequence group, and each first partial sequence group includes at least one first partial sequence. That is, the first synchronization sequence is divided into several portions, and each portion is referred to as a first partial sequence group.

It is assumed that the (N₁+1) repeated first synchronization sequences include Z₁ first partial sequence groups in total. Z₁≥(N₁+1), or Z₁ is an integer multiple of (N₁+1). Then, an i^{th} first partial sequence group in the first synchronization sequence repeated N₁ times is multiplied by an i^{th} sequence element in the pseudo-random sequence. That is, the first sequence group is acquired by multiplying the Z₁ first partial sequence groups by Z₁ sequence elements. It is assumed that the pseudo-random sequence C=[C₁, C₂, . . . , C_{Z}]. Z=Z₁≥(N₁+1).

Then, the first sequence group=[C₁*Q(1), C₂*Q(2), . . . , C_{Z}*Q(Z)]. Q(i) represents the i^{th} first partial sequence group in the (N₁+1) repeated first synchronization sequences, and Cᵢ represents the i^{th} sequence element in Z sequence elements.

It should be noted that the sequence number i refers to a sequence number of the first synchronization sequence group in the Z₁ first partial sequence groups in the first synchronization sequence repeated N₁ times. Exemplarily, the first synchronization sequence is [1, 0, 1, 0], and the first synchronization sequence includes two first partial sequence groups [1, 0]. Then, the first synchronization sequence repeated twice includes 3*2=6 first partial sequence groups in total. In the case where the sequence number is 2, the sequence number refers to a second first partial sequence group in {[1, 0, 1, 0], [1, 0, 1, 0], [1, 0, 1, 0]}(i.e., the second [1, 0] from the left, corresponding to the third digit from the left and the fourth digit from the left). In the case where the sequence number is 5, the sequence number refers to a fifth first partial sequence group in {[1, 0, 1, 0], [1, 0, 1, 0], [1, 0, 1, 0]}(i.e., the fifth [1, 0] from the left, corresponding to the ninth digit from the left and the tenth digit from the left).

Exemplarily, the first sequence group is formed based on the first synchronization sequence repeated twice, that is, the first sequence group is formed based on three repeated first synchronization sequences. Each first synchronization sequence corresponds to two symbol groups, and each symbol group includes at least one symbol. Then, the first synchronization sequence repeated twice corresponds to six symbol groups in total. Each first synchronization sequence may be divided into two first partial sequence groups based on the symbol groups. Then, the first synchronization sequence repeated twice corresponds to six first partial sequence groups in total.

The first synchronization sequence repeated twice=[Q₁, Q₂, Q₃, Q₄, Q₅, Q₆]. Qᵢ represents the i^{th} first partial sequence group in the six first partial sequence groups, and Q₁=Q₃=Q₅, and Q₂=Q₄=Q₆. The pseudo-random sequence C=[C₁, C₂, C₃, C₄, C₅, C₆]. Cᵢ represents the i^{th} sequence element in the six sequence elements.

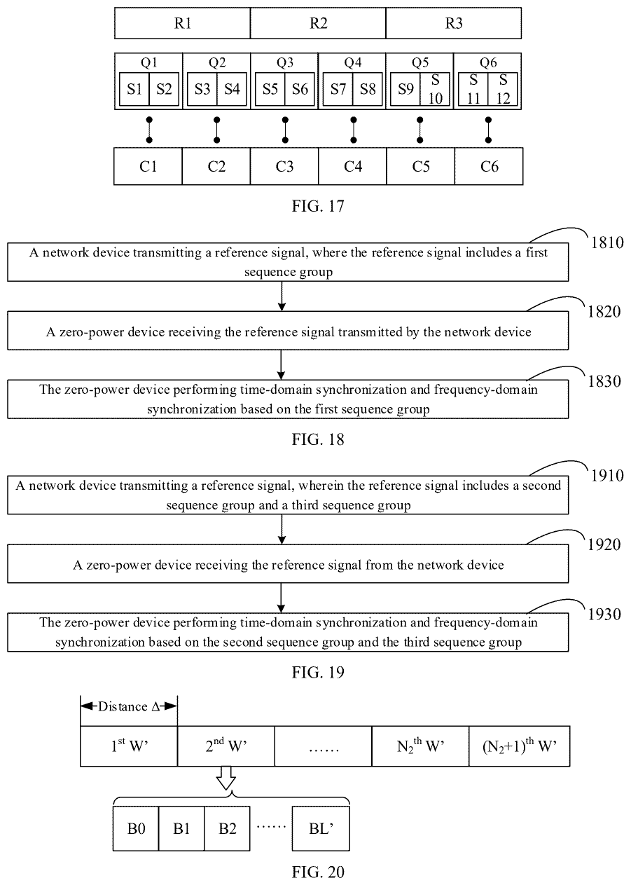

Then, as illustrated in FIG. 17, the first sequence group=[C₁*Q₁, C₂*Q₂, C₃*Q₃, C₄*Q₄, C₅*Q₅, C₆*Q₆].

Exemplarily, the pseudo-random sequence=[+1, −1, +1, −1, −1, +1], and the first synchronization sequence=[1, 0, 1, 0]. The first partial sequence group=[1, 0]. Then, the first synchronization sequence repeated twice={[1, 0, 1, 0], [1, 0, 1, 0], [1, 0, 1, 0]}, and the first sequence group={[1, 0, −1, 0], [1, 0, −1, 0], [−1, 0, 1, 0]}.

Exemplarily, the pseudo-random sequence C=[+1, −1, +1, −1, −1, +1], and the first synchronization sequence=[1, 0, 1, 1]. Every two bits are grouped into one first partial sequence group. Then, each first synchronization sequence is divided into two different first partial sequence groups, that is, [1, 0] and [1, 1]. Assuming that bit 1 in the synchronization sequence corresponds to two sampling points (a1, a2) in the time domain and bit 0 in the synchronization sequence corresponds to two sampling points (b1, b2) in the time domain, then the first synchronization sequence repeated twice={[1, 0, 1, 1], [1, 0, 1, 1], [1, 0, 1, 1]}={[a1, a2, b1, b2, a1, a2, a1, a2], [a1, a2, b1, b2, a1, a2, a1, a2], [a1, a2, b1, b2, a1, a2, a1, a2]}. Then, the first sequence group={[a1, a2, b1, b2, −a1, −a2, −a1, −a2], [a1, a2, b1, b2, −a1, −a2, −a1, −a2], [−a1, −a2, −b1, −b2, a1, a2, a1, a2]}. In some embodiments, the first sequence group is carried in a WUR-Sync field for transmission.

In some embodiments, a signal corresponding to the first sequence group is referred to as a WUR-Sync signal.

### In a Second Solution, the Reference Signal Includes at Least Two Sequence Groups

For descriptive distinction, the sequence groups involved in the second solution are referred to as a second sequence group and a third sequence group, the synchronization sequence used for forming the second sequence group is referred to as a second synchronization sequence, and the synchronization sequence used for forming the third sequence group is referred to as a third synchronization sequence.

The second sequence group is the same as or different from the first sequence group, and the second sequence group is different from the third sequence group.

In some embodiments, a sampling rate of the third sequence group is higher than that of the second sequence group.

### 1. Second Sequence Group

The second sequence group corresponds to at least one bit, that is, a bit length of the second sequence group is greater than or equal to 1. In some embodiments, each bit corresponds to at least one time-domain unit, or each bit corresponds to at least one sampling point.

In some embodiments, the second sequence group is formed based on the second synchronization sequence corresponding to the at least one time-domain unit. That is, the second synchronization sequence corresponding to the at least one time-domain unit is understood as the second synchronization sequence occupying one or more time-domain units in the time domain.

In some embodiments, the second sequence group is formed based on the second synchronization sequence corresponding to the at least one sampling point. That is, the second synchronization sequence corresponding to the at least one sampling point is understood as the second synchronization sequence corresponding to one or more sampling points in the time domain.

In some embodiments, the second sequence group is formed based on the second synchronization sequence corresponding to a portion of a time-domain unit. That is, the second synchronization sequence corresponding to the portion of the time-domain unit is understood as the second synchronization sequence occupying a portion of the time-domain unit in the time domain. In this case, the time-domain unit corresponds to at least two second synchronization sequences.

In some embodiments, the second sequence group is formed based on two or more of the second synchronization sequence corresponding to the at least one time-domain unit, the second synchronization sequence corresponding to the at least one sampling point, or the second synchronization sequence corresponding to the portion of the time-domain unit. Exemplarily, the second sequence group includes the second synchronization sequence corresponding to the at least one time-domain unit, and includes the second synchronization sequence corresponding to the at least one sampling point. Exemplarily, the second sequence group includes the second synchronization sequence corresponding to the portion of the time-domain unit, and includes the second synchronization sequence corresponding to the at least one sampling point.

The second sequence group is formed based on the second synchronization sequence, which means that the second synchronization sequence corresponding to the second sequence group may be repeated or non-repeated.

(1) The second synchronization sequence corresponding to the second sequence group is non-repeated, which may also be understood as the second sequence group being formed based on the second synchronization sequence repeated 0 times. In this case, the second sequence group includes the second synchronization sequence, or the second sequence group is a randomized sequence group formed based on the second synchronization sequence.

In some embodiments, considering the granularity of the randomization processing, the following two randomization processing modes for the non-repeated second synchronization sequence are provided in the embodiments of the present disclosure:

In randomization processing mode one, a second partial sequence in the second synchronization sequence is in one-to-one correspondence with the sequence elements.

In some embodiments, the second synchronization sequence includes at least one second partial sequence. That is, the second synchronization sequence is divided into several portions, and each portion is referred to as a second partial sequence.

It is assumed that the second synchronization sequence includes Y₂ second partial sequences in total. Y₂≥1. Then, an i^{th} second partial sequence in the second synchronization sequence is multiplied by an i^{th} sequence element in the pseudo-random sequence. That is, the second sequence group is acquired by multiplying the Y₂ second partial sequences by Y₂ sequence elements. It is assumed that the pseudo-random sequence C=[C₁, C₂, . . . , C_{Y}]. Y=Y₂≥1.

Then, the second sequence group=[C₁*S(1), C₂*S(2), . . . , C_{Y}*S(Y₂)]. S(i) represents the i^{th} second partial sequence in the second synchronization sequence, and Cᵢ represents the i^{th} sequence element in Y sequence elements.

Exemplarily, the second sequence group is formed based on the second synchronization sequence. The second synchronization sequence corresponds to three symbols. The second synchronization sequence may be divided into three second partial sequences based on the symbols.

The second synchronization sequence=[S₁, S₂, S₃]. Sᵢ represents the i^{th} second partial sequence in the three second partial sequences. The pseudo-random sequence C=[C₁, C₂, C₃]. Cᵢ represents the i^{th} sequence element in the three sequence elements.

Then, the second sequence group=[C₁*S₁, C₂*S₂, C₃*S₃].

In randomization processing mode two, a second partial sequence group in the second synchronization sequence is in one-to-one correspondence with the sequence elements.

In some embodiments, the second synchronization sequence includes at least one second partial sequence group, and each second partial sequence group includes at least one second partial sequence. That is, the second synchronization sequence is divided into several portions, and each portion is referred to as a second partial sequence group.

It is assumed that the second synchronization sequence includes Z₂ second partial sequences in total. Z₂≥1. Then, an i^{th} second partial sequence group in the second synchronization sequence is multiplied by an i^{th} sequence element in the pseudo-random sequence. That is, the second sequence group is acquired by multiplying the Z₂ second partial sequence groups by Z₂ sequence elements. It is assumed that the pseudo-random sequence C=[C₁, C₂, . . . , C_{Z}]. Z=Z₂≥1.

Then, the second sequence group=[C₁*Q(1), C₂*Q(2), . . . , C_{Z}*Q(Z₂)]. Q(i) represents the i^{th} second partial sequence group in the second synchronization sequence, and Cᵢ represents the i^{th} sequence element in Z sequence elements.

Exemplarily, the second sequence group is formed based on the second synchronization sequence. The second synchronization sequence corresponds to two symbol groups, and each symbol group includes at least one symbol. The second synchronization sequence may be divided into two second partial sequence groups based on the symbol groups.

The second synchronization sequence=[Q₁, Q₂]. Qᵢ represents the i^{th} second partial sequence group in the two second partial sequence groups. The pseudo-random sequence C=[C₁, C₂]. Cᵢ represents the i^{th} sequence element in the two sequence elements.

In some embodiments, the second synchronization sequence is not subjected to randomization processing.

Then, the second sequence group=[C₁*Q₁, C₂*Q₂].

(2) The second synchronization sequence corresponding to the second sequence group is repeated, which may also be understood as the second sequence group being formed based on the second synchronization sequence repeated N₂ times. N₂ is an integer greater than or equal to 1.

For the two cases of “the second sequence group being formed based on the second synchronization sequence repeated N₂ times” and the randomization processing mode, reference may be made to the related content of “the first sequence group being formed based on the first synchronization sequence repeated N₂ times” as described above.

In one case, the second sequence group includes the second synchronization sequence repeated N₂ times, that is, the (N₂+1) repeated second synchronization sequences form the second sequence group.

In another case, the second sequence group is a randomized sequence group formed based on the second synchronization sequence repeated N₂ times.

Considering the granularity of the randomization processing, the following three randomization processing modes for the repeated second synchronization sequence are provided in the embodiments of the present disclosure:

In randomization processing mode one, the second synchronization sequence is in one-to-one correspondence with the sequence elements.

An i^{th} second synchronization sequence in the second synchronization sequence repeated N₂ times is multiplied by an i^{th} sequence element in the pseudo-random sequence. That is, the second sequence group is acquired by multiplying the (N₂+1) repeated second synchronization sequences by (N₂+1) sequence elements.

It is assumed that the pseudo-random sequence C=[C₁, C₂, . . . , C_{X}]. X=(N₂+1).

Then, the second sequence group=[C₁*R(1), C₂*R(2), . . . , C_{X}*R(N₂+1)]. R(i) represents the i^{th} second synchronization sequence in the (N₂+1) repeated second synchronization sequences, and Cᵢ represents the i^{th} sequence element in the (N₂+1) sequence elements.

In randomization processing mode two, a second partial sequence in the second synchronization sequence is in one-to-one correspondence with the sequence elements.

In some embodiments, a second synchronization sequence includes at least one second partial sequence. That is, the second synchronization sequence is divided into several portions, and each portion is referred to as a second partial sequence.

It is assumed that the (N₂+1) repeated second synchronization sequences include Y₂ second partial sequences in total. Y₂≥(N₂+1), or Y₂ is an integer multiple of (N₂+1). Then, an i^{th} second partial sequence in the second synchronization sequence repeated N₂ times is multiplied by an i^{th} sequence element in the pseudo-random sequence. That is, the second sequence group is acquired by multiplying the Y₂ second partial sequences by Y₂ sequence elements. It is assumed that the pseudo-random sequence C=[C₁, C₂, . . . , C_{Y}], where Y=Y₁(N₂+1).

Then, the second sequence group=[C₁*S(1), C₂*S(2), . . . , C_{Y}*S(Y₁)]. S(i) represents the i^{th} second partial sequence in the (N₂+1) repeated second synchronization sequences, and Cᵢ represents the i^{th} sequence element in Y sequence elements.

In randomization processing mode three, a second partial sequence group in the second synchronization sequence is in one-to-one correspondence with the sequence elements.

In some embodiments, a second synchronization sequence includes at least one second partial sequence group, and each second partial sequence group includes at least one second partial sequence. That is, the second synchronization sequence is divided into several portions, and each portion is referred to as a second partial sequence group.

It is assumed that the (N₂+1) repeated second synchronization sequences include Z₂ second partial sequence groups in total. Z₂≥(N₂+1), or Z₂ is an integer multiple of (N₂+1). Then, an i^{th} second partial sequence group in the second synchronization sequence repeated N₂ times is multiplied by an i^{th} sequence element in the pseudo-random sequence. That is, the second sequence group is acquired by multiplying the Z₂ second partial sequence groups by Z sequence elements.

It is assumed that the pseudo-random sequence C=[C₁, C₂, . . . , C_{Z}]. Z=Z₂≥(N₂+1).

Then, the second sequence group=[C₁*Q(1), C₂*Q(2), . . . , C_{Z}*Q(Z₂)]. Q(i) represents the i^{th} second partial sequence group in the (N₂+1) repeated second synchronization sequences, and Cᵢ represents the i^{th} sequence element in the Z sequence elements.

### 2. Third Sequence Group

The third sequence group corresponds to at least one bit, that is, a bit length of the third sequence group is greater than or equal to 1. In some embodiments, each bit corresponds to at least one time-domain unit, or each bit corresponds to at least one sampling point.

Exemplarily, the third synchronization sequence repeated N₃ times is illustrated in FIG. 9, where the third sequence group corresponds to (N₃+1) repeated third synchronization sequences G, which are separately represented by 1^{st} G, 2^{nd} G, . . . , N₃^{th} G, and (N₃+1)^{th} G. The third synchronization sequence G corresponds to q bits, where q≥1, and the q bits are separately represented by B0, B1, . . . , and Bq. Each bit corresponds to at least one sampling point, or corresponds to at least one time-domain unit, or corresponds to a portion of a time-domain unit. In FIG. 9, each bit corresponds to one sampling point.

In the case where the time-domain unit is a symbol, each bit corresponds to at least one symbol; or each bit corresponds to a portion of a symbol. For example, each bit corresponds to 1/t of a symbol.

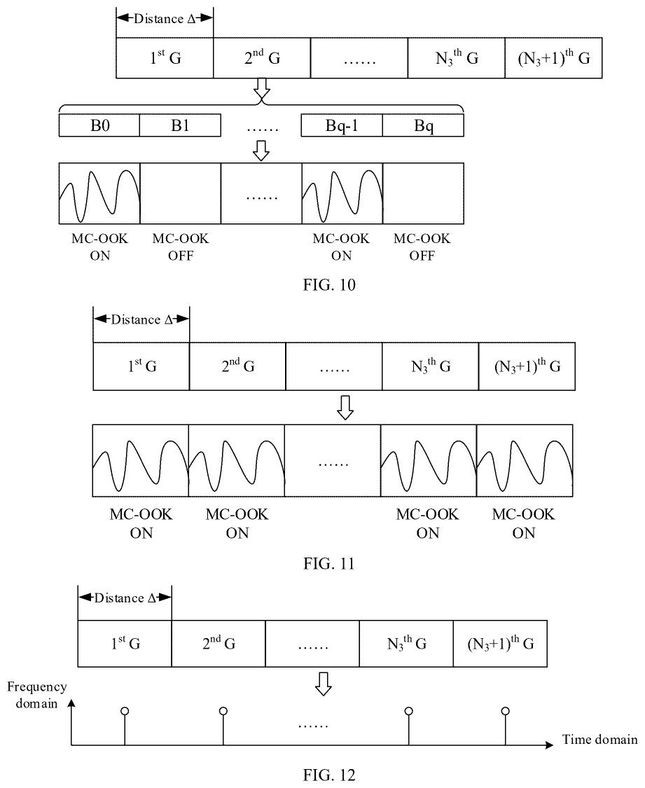

In some embodiments, different bits in the same third synchronization sequence G correspond to the same symbol. Alternatively, different bits in the same third synchronization sequence G correspond to different symbols. As illustrated in FIG. 10, a first bit position B0 in the third synchronization sequence G corresponds to an MC-OOK ON symbol, a second bit position B1 corresponds to an MC-OOK OFF symbol, . . . , a (q−1)^{th} bit position Bq−1 corresponds to an MC-OOK ON symbol, and a q^{th} bit position Bq corresponds to an MC-OOK OFF symbol.

In some embodiments, the third sequence group is formed based on the third synchronization sequence corresponding to the at least one time-domain unit. That is, the third synchronization sequence corresponding to the at least one time-domain unit is understood as the third synchronization sequence occupying one or more time-domain units in the time domain.

Exemplarily, the third synchronization sequence repeated N₃ times is illustrated in FIG. 11, where the third sequence group corresponds to (N₃+1) repeated third synchronization sequences G, which are separately represented by 1^{st} G, 2^{nd} G, . . . , N₃^{th} G, and (N₃+1)^{th} G. The third synchronization sequence G corresponds to a time-domain unit. In FIG. 11, the time-domain unit is an MC-OOK ON symbol. Each third synchronization sequence G corresponds to one MC-OOK ON symbol.

In some embodiments, the third sequence group is formed based on the third synchronization sequence corresponding to the at least one sampling point. That is, the third synchronization sequence corresponding to the at least one sampling point is understood as the third synchronization sequence corresponding to one or more sampling points in the time domain.

Exemplarily, the third synchronization sequence repeated N₃ times is illustrated in FIG. 12, where the third sequence group corresponds to (N₃+1) repeated third synchronization sequences G, which are separately represented by 1^{st} G, 2^{nd} G, . . . , N₃^{th} G, and (N₃+1)^{th} G. The third synchronization sequence G corresponds to one sampling point.

In some embodiments, the third sequence group is formed based on the third synchronization sequence corresponding to a portion of a time-domain unit. That is, the third synchronization sequence corresponding to the portion of the time-domain unit is understood as the third synchronization sequence occupying a portion of the time-domain unit in the time domain. In this case, one time-domain unit corresponds to at least two third synchronization sequences.

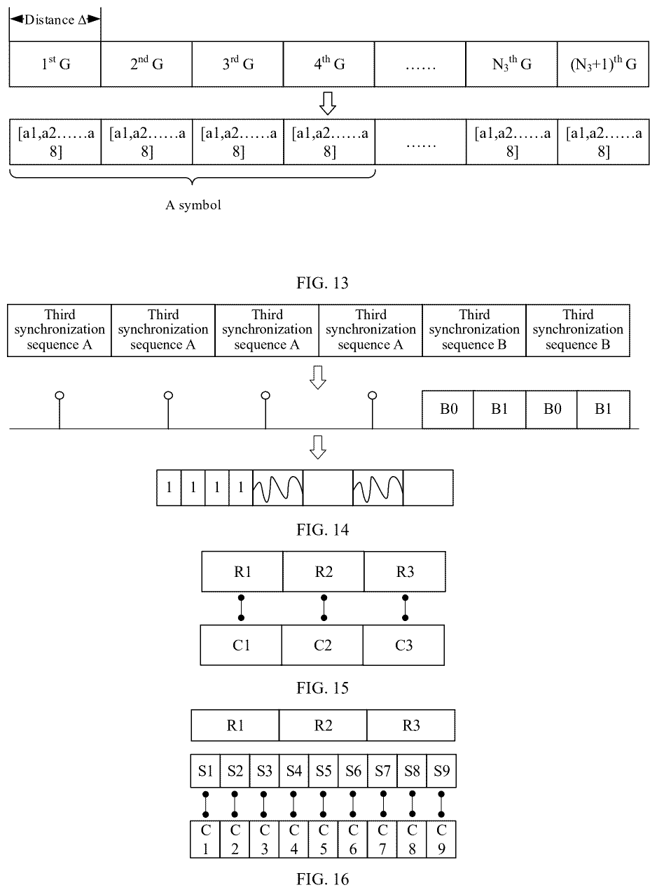

Exemplarily, the third synchronization sequence repeated N₃ times is illustrated in FIG. 13, where the third sequence group corresponds to (N₃+1) repeated third synchronization sequences G, which are separately represented by 1^{st} G, 2^{nd} G, . . . , N₃^{th} G, and (N₃+1)^{th} G. In FIG. 13, the time-domain unit is a symbol and a third synchronization sequence G occupies ¼ of a symbol in the time domain. A symbol corresponds to four identical third synchronization sequences G, and the third synchronization sequence G=[a1, a2, . . . , a8].

In some embodiments, the third sequence group is formed based on two or more of the third synchronization sequence corresponding to the at least one time-domain unit, the third synchronization sequence corresponding to the at least one sampling point, or the third synchronization sequence corresponding to the portion of one time-domain unit. Exemplarily, the third sequence group includes the third synchronization sequence corresponding to the at least one time-domain unit, and includes the third synchronization sequence corresponding to the at least one sampling point. Exemplarily, the third sequence group includes the third synchronization sequence corresponding to the portion of the time-domain unit, and includes the third synchronization sequence corresponding to the at least one sampling point.

Exemplarily, as illustrated in FIG. 14, the third sequence group includes four repeated third synchronization sequences A, and further includes two repeated third synchronization sequences B. A third synchronization sequence A corresponds to a sampling point. A third synchronization sequence B corresponds to two bits, and each bit corresponds to at least one sampling point or at least one time-domain unit. In FIG. 14, first bit position B0 in the third synchronization sequence B corresponds to an MC-OOK ON symbol and second bit position B1 corresponds to an MC-OOK OFF symbol.

In some embodiments, in the case where the third sequence group corresponds to two or more types of third synchronization sequences, different third synchronization sequences are used for frequency offset estimation with different accuracies. For example, the third synchronization sequence A is used for coarse frequency offset estimation, and the third synchronization sequence B is used for fine frequency offset estimation.

Exemplarily, a distance Δ between two third synchronization sequences A is small, and the third synchronization sequence A is used for coarse frequency offset estimation. A distance Δ between two third synchronization sequences B is large, and the third synchronization sequence B is used for fine frequency offset estimation.

The third sequence group is formed based on a third synchronization sequence repeated N₃ times, and N₃ is an integer greater than or equal to 1. This may also be understood as the third sequence group being formed based on (N₃+1) repeated third synchronization sequences.

It should be noted that “the third sequence group being formed based on the third synchronization sequence repeated N₃ times” means that the following two cases are possible for the formation of the third sequence group:

In one case, the third sequence group includes the third synchronization sequence repeated N₃ times, that is, the (N₃+1) repeated third synchronization sequences form the third sequence group.

In another case, the third sequence group is a randomized sequence group formed based on the third synchronization sequence. This may be understood as the third sequence group including sequences acquired by performing randomization processing on the third synchronization sequence repeated N₃ times, that is, the third sequence group formed by performing randomization processing on the (N₃+1) repeated third synchronization sequences.

This case takes into account the fact that the repetition of the synchronization sequence may cause the energy of the reference signal to be overly concentrated within the bandwidth, which is detrimental to the robustness of the reference signal. The formed reference signal has a more uniform power distribution upon the randomization processing, which is conducive to the transmission quality and stability of the reference signal.

Considering the granularity of the randomization processing, the following three randomization processing modes for the third synchronization sequence are provided in the embodiments of the present disclosure:

In randomization processing mode one, the third synchronization sequence is in one-to-one correspondence with the sequence elements.

An i^{th} third synchronization sequence in the third synchronization sequence repeated N₃ times is multiplied by an i^{th} sequence element in the pseudo-random sequence. That is, the third sequence group is acquired by multiplying the (N₃+1) repeated third synchronization sequences by (N₃+1) sequence elements.

It is assumed that the pseudo-random sequence C=[C₁, C₂, . . . , C_{X}], where X=(N₃+1).

Then, the third sequence group=[C₁*R(1), C₂*R(2), . . . , C_{X}*R(N₃+1)]. R(i) represents the i^{th} third synchronization sequence in the (N₃+1) repeated third synchronization sequences, and Cᵢ represents the i^{th} sequence element in the (N₃+1) sequence elements.

Exemplarily, the third sequence group is formed based on the third synchronization sequence repeated twice, that is, the third sequence group is formed based on three repeated third synchronization sequences.

The third synchronization sequence repeated twice=[R₁, R₂, R₃]. Rᵢ represents the i^{th} third synchronization sequence in the three repeated third synchronization sequences. The pseudo-random sequence C=[C₁, C₂, C₃]. Cᵢ represents the i^{th} sequence element in the three sequence elements.

Then, as illustrated in FIG. 15, the third sequence group=[C₁*R₁, C₂*R₂, C₃*R₃].

In randomization processing mode two, a third partial sequence in the third synchronization sequence is in one-to-one correspondence with the sequence elements.

In some embodiments, a third synchronization sequence includes at least one third partial sequence. That is, the third synchronization sequence is divided into several portions, and each portion is referred to as a third partial sequence.

It is assumed that the (N₃+1) repeated third synchronization sequences include Y₃ third partial sequences in total. Y₃≥(N₃+1), or Y₃ is an integer multiple of (N₃+1). Then, an i^{th} third partial sequence in the third synchronization sequence repeated N₃ times is multiplied by an i^{th} sequence element in the pseudo-random sequence. That is, the third sequence group is acquired by multiplying the Y₃ third partial sequences by Y₃ sequence elements. It is assumed that the pseudo-random sequence C=[C₁, C₂, . . . , C_{Y}], where Y=Y₃≥(N₃+1).

Then, the third sequence group=[C₁*S(1), C₂*S(2), . . . , C_{Y}*S(Y₃)]. S(i) represents the i^{th} third partial sequence in the (N₃+1) repeated third synchronization sequences, and Cᵢ represents the i^{th} sequence element in Y sequence elements.

It should be noted that the sequence number i refers to a sequence number of the third synchronization sequence in the Y₁ first partial sequences in the first synchronization sequence repeated N₁ times. Exemplarily, the first synchronization sequence is [1, 0, 1], and the first synchronization sequence includes three first partial sequences. Then, the first synchronization sequence repeated once includes 3*2=6 first partial sequences in total. In the case where the sequence number is 2, the sequence number refers to a second first partial sequence in {[1, 0, 1], [1, 0, 1]}(i.e., the second digit from the left, “0”). In the case where the sequence number is 5, the sequence number refers to a fifth first partial sequence in {[1, 0, 1], [1, 0, 1]}(i.e., the fifth digit from the left, “0”).

Exemplarily, the third sequence group is formed based on the third synchronization sequence repeated twice, that is, the third sequence group is formed based on three repeated third synchronization sequences. Each third synchronization sequence corresponds to three symbols. Then, the third synchronization sequence repeated twice corresponds to nine symbols in total. Each third synchronization sequence may be divided into three third partial sequences based on the symbols. Then, the third synchronization sequence repeated twice corresponds to nine third partial sequences in total.

The third synchronization sequence repeated twice=[S₁, S₂, S₃, S₄, S₅, S₆, S₇, S₈, S₉]. Sᵢ represents the i^{th} third partial sequence in the nine third partial sequences, and S₁=S₄=S₇, S₂=S₅=S₈, and S₃=S₆=S₉. The pseudo-random sequence C=[C₁, C₂, C₃, C₄, C₅, C₆, C₇, C₈, C₉]. Cᵢ represents the i^{th} sequence element in the nine sequence elements.

Then, the third sequence group=[C₁*S₁, C₂*S₂, C₃*S₃, C₄*S₄, C₅*S₅, C₆*S₆, C₇*S₇, C₈*S₈, C₉*S₉], as illustrated in FIG. 16.

In randomization processing mode three, a third partial sequence group in the third synchronization sequence is in one-to-one correspondence with the sequence elements.

In some embodiments, a third synchronization sequence includes at least one third partial sequence group, and each third partial sequence group includes at least one third partial sequence. That is, the third synchronization sequence is divided into several portions, and each portion is referred to as a third partial sequence group.

It is assumed that the (N₃+1) repeated third synchronization sequences include Z₃ third partial sequences in total. Z₃≥(N₃+1), or Z₃ is an integer multiple of (N₃+1). Then, an i^{th} third partial sequence group in the third synchronization sequence repeated N₃ times is multiplied by an i^{th} sequence element in the pseudo-random sequence. That is, the third sequence group is acquired by multiplying Z₃ third partial sequence groups by Z₃ sequence elements. It is assumed that the pseudo-random sequence C=[C₁, C₂, . . . , C_{Z}], where Z=Z₃≥(N₃+1).

Then, the third sequence group=[C₁*Q(1), C₂*Q(2), . . . , C_{Z}*Q(Z₃)]. Q(i) represents the i^{th} third partial sequence group in the (N₃+1) repeated third synchronization sequences, and Cᵢ represents the i^{th} sequence element in Z sequence elements.

Exemplarily, the third sequence group is formed based on the third synchronization sequence repeated twice, that is, the third sequence group is formed based on three repeated third synchronization sequences. Each third synchronization sequence corresponds to two symbol groups, and each symbol group includes at least one symbol. Then, the third synchronization sequence repeated twice corresponds to six symbol groups in total. Each third synchronization sequence may be divided into two third partial sequence groups based on the symbol groups. Then, the third synchronization sequence repeated twice corresponds to six third partial sequence groups in total.

The third synchronization sequence repeated twice=[Q₁, Q₂, Q₃, Q₄, Q₅, Q₆]. Qᵢ represents the i^{th} third partial sequence group in the six third partial sequence groups, and Q₁=Q₃=Q₅, and Q₂=Q₄=Q₆. The pseudo-random sequence C=[C₁, C₂, C₃, C₄, C₅, C₆]. Cᵢ represents the i^{th} sequence element in the six sequence elements.

Then, as illustrated in FIG. 17, the third sequence group=[C₁*Q₁, C₂*Q₂, C₃*Q₃, C₄*Q₄, C₅*Q₅, C₆*Q₆].

In some embodiments, both the second sequence group and the third sequence group are carried in a WUR-Sync field for transmission. Alternatively, the second sequence group is carried in a WUR-Sync field for transmission, and the third sequence group is carried in a field other than the WUR-Sync field for transmission.

In some embodiments, a signal corresponding to the second sequence group is referred to as a Time-Sync signal, and a signal corresponding to the third sequence group is referred to as a Freq-Sync signal.

It should be noted that in the case where the reference signal includes the second sequence group and the third sequence group, at least one of the second sequence group or the third sequence group is subjected to randomization processing, or neither the second sequence group nor the third sequence group is subjected to randomization processing. For example, the second sequence group is not subjected to randomization processing, and the third sequence group is subjected to randomization processing.

In the case where both the second sequence group and the third sequence group are subjected to randomization processing, the randomization processing modes used for the second sequence group and the third sequence group may be the same or different. For example, both the second sequence group and the third sequence group use a mode of multiplying a synchronization sequence by a sequence element. For example, the second sequence group uses a mode of multiplying a partial sequence in the synchronization sequence by a sequence element, and the third sequence group uses a mode of multiplying a synchronization sequence by a sequence element. That is, the granularities of randomization processing of the second sequence group and the third sequence group may be the same or different.

Next, an example in which the reference signal includes the first sequence group is used to schematically describe the design and use of the reference signal.

FIG. 18 is a flowchart of a communication method for synchronization according to some exemplary embodiments of the present disclosure. The method is performed by a zero-power device and a network device. The method includes the following processes.

In S1810, the network device transmits a reference signal, wherein the reference signal includes a first sequence group.

The reference signal is used for time-domain synchronization and frequency-domain synchronization of the zero-power device.

The first sequence group is formed based on a first synchronization sequence repeated N₁ times, and N₁ is an integer greater than or equal to 1.

The first sequence group corresponds to at least one bit, that is, a bit length of the first sequence group is greater than or equal to 1. In some embodiments, each bit corresponds to at least one time-domain unit, or each bit corresponds to at least one sampling point.

In some embodiments, the first sequence group is formed based on the first synchronization sequence corresponding to the at least one time-domain unit. That is, the first synchronization sequence corresponds to a time-domain unit or a plurality of time-domain units, and the first sequence group corresponds to the first synchronization sequence repeated N₁ times.

In some embodiments, the first sequence group is formed based on the first synchronization sequence corresponding to the at least one sampling point. That is, the first synchronization sequence corresponds to a sampling point or a plurality of sampling points, and the first sequence group corresponds to the first synchronization sequence repeated N₁ times.

In some embodiments, the first sequence group is formed based on the first synchronization sequence corresponding to a portion of a time-domain unit. That is, the first synchronization sequence corresponds to the portion of the time-domain unit, and the first sequence group corresponds to the first synchronization sequence repeated N₁ times.

Exemplarily, the first sequence group is illustrated in FIG. 8. The first sequence group corresponds to a first synchronization sequence W repeated N₁ times, that is, the first sequence group corresponds to (N₁+1) repeated first synchronization sequences W.

The first synchronization sequence W corresponds to L bits. L≥1. Each bit corresponds to at least one sampling point, or corresponds to at least one time-domain unit, or corresponds to a portion of a time-domain unit. In the case where the time-domain unit is a symbol, each bit corresponds to at least one symbol; or each bit corresponds to a portion of a symbol. For example, each bit corresponds to 1/t of a symbol.

In some embodiments, different bits in the L bits correspond to the same number of sampling points or the same number of time-domain units.

In some embodiments, different bits in the L bits correspond to different numbers of sampling points or different numbers of time-domain units. Exemplarily, the first synchronization sequence W corresponds to three bits, the first bit corresponds to one sampling point, the second bit corresponds to three sampling points, and the third bit corresponds to two sampling points. Exemplarily, the first synchronization sequence W corresponds to eight bits, the first four bits correspond to two QPSK symbols, and the last four bits correspond to three QPSK symbols.

Furthermore, the time and frequency synchronization performance of the reference signal can be further improved or ensured in the following two aspects.

I. Considering the range of frequency offset estimation, the range of frequency offset estimation may be expanded by reducing the distance Δ between two first synchronization sequences.

At least the following two modes are available for reducing the distance Δ.

1. A value of L is reduced, that is, the number of bits corresponding to the first synchronization sequence W is reduced.

The value of L is minimized, so as to expand the range of frequency offset estimation as much as possible. Therefore, 1≤L≤32.

2. A time-domain length corresponding to each bit is reduced.

For example, the number of sampling points corresponding to each bit is reduced, or the length of the time-domain unit corresponding to each bit is reduced. The length of the time-domain unit may be expressed in time, or may be represented by the number of sampling points.

Exemplarily, a symbol corresponds to N_{fft}+N_{cp} sampling points. N_{fft} represents a corresponding number of sampling points upon a fast Fourier transform (FFT), and N_{cp} represents a number of sampling points corresponding to a cyclic prefix (CP).

Then, the time-domain length corresponding to each bit may be reduced by reducing N_{cp}, for example, by setting N_{cp} to 0.

Alternatively, the time-domain length corresponding to each bit may be reduced by reducing a length of a data portion. For example, N_{fft}=64, a piece of non-zero data is placed in every K subcarriers in the case where an OFDM waveform is generated. In this way, upon an inverse fast Fourier transform (IFFT), K=4 repeated subsequences are acquired. The length of each subsequence is N_{fft}/K=16. Then, one of the K repeated subsequences is retained (for example, the first repeated subsequence is retained, and the other portions are discarded).

It should be understood that mode 1 and mode 2 may be used separately, or may be used in combination. For example, both the value of L and the time-domain length corresponding to each bit are reduced. It should be understood that the reduction of N_{cp} and the reduction of the length of the data portion may be used separately, or may be used in combination. For example, both N_{cp} and the length of the data portion are reduced.

That is, the reduction of the distance Δ may be implemented by reducing the bit length of the first synchronization sequence W (that is, the value of L). Alternatively, the total number of sampling points/total length of time-domain units corresponding to the L bits may be reduced by reducing the number of sampling points/length of the time-domain unit corresponding to each bit, thereby reducing the distance Δ. Alternatively, the distance Δ may be reduced by both reducing the bit length of the first synchronization sequence W (that is, the value of L) and reducing the number of sampling points/length of the time-domain unit corresponding to each bit.

II. Considering the performance of time and frequency synchronization, the value of N₁ may be maximized to improve the performance of time-domain synchronization and frequency-domain synchronization.

However, a larger value of N₁ indicates a larger amount of data that needs to be cached and processed by the zero-power device. In the case where the value of N₁ is excessively large, storage, power consumption, or the like of the zero-power device may be adversely affected. Therefore, 1≤N₁≤31.

It should be understood that the reduction of the distance Δ and the increase of the value of N₁ may be used separately, or may be used in combination. For example, the distance Δ is reduced and the value of N₁ is increased. For example, the distance Δ is reduced but the value of N₁ is not increased. For example, the value of N₁ is increased but the distance Δ is not reduced.

Exemplarily, in the case where L=32 and N₁=1, the bit length of the first synchronization sequence W is 32, that is, the first synchronization sequence W corresponds to 32 bits or bit positions. Moreover, the first sequence group is formed based on the first synchronization sequence W repeated once, that is, the first sequence group corresponds to two repeated first synchronization sequences W.

Exemplarily, in the case where L=4 and N₁=8, the bit length of the first synchronization sequence W is 4, that is, the first synchronization sequence W corresponds to four bits or bit positions. Moreover, the first sequence group is formed based on the first synchronization sequence W repeated eight times, that is, the first sequence group corresponds to nine repeated first synchronization sequences W.

Exemplarily, in the case where L=6 and N₁=10, the bit length of the first synchronization sequence W is 6, that is, the first synchronization sequence W corresponds to six bits or bit positions. Moreover, the first sequence group is formed based on the first synchronization sequence W repeated ten times, that is, the first sequence group corresponds to eleven repeated first synchronization sequences W.

Exemplarily, in the case where L=1 and N₁=31, the bit length of the first synchronization sequence W is 1, that is, the first synchronization sequence W corresponds to one bit or bit position. Moreover, the first sequence group is formed based on the first synchronization sequence W repeated 31 times, that is, the first sequence group corresponds to 32 repeated first synchronization sequences W. In the case where L=1 and each bit corresponds to a symbol (for example, each bit corresponds to an MC-OOK symbol), the first sequence group is formed based on a symbol repeated 31 times (for example, the first sequence group is a waveform formed based on an MC-OOK ON symbol repeated 31 times).

Furthermore, considering that the repeated first synchronization sequences W may cause the frequency points corresponding to the first sequence group to be too concentrated, resulting in a high energy impact in the vicinity of the central frequency point, which violates certain spectrum regulations and is detrimental to the synchronization performance, in the embodiments of the present disclosure, randomization processing (or referred to as randomizing processing) may be further performed on the repeated first synchronization sequences W, such that the energy distribution of the first sequence group becomes more uniform in the frequency domain. For a randomization processing mode, reference is made to the foregoing descriptions, which are not repeated herein.

Exemplarily, the first synchronization sequence W repeated N₁ times is multiplied by (N₁+1) sequence elements in a pseudo-random sequence to acquire the first sequence group. Therefore, the first sequence group is a randomized sequence group formed based on the first synchronization sequence W repeated N₁ times. Exemplarily, the pseudo-random sequence includes sequence elements with values of +1 and −1, or includes sequence elements with values of +j and −j, or includes sequence elements with values of +1, −1, +j, and −j.

It should be understood that the above two aspects may be used separately, or may be used in combination. For example, the distance between two first synchronization sequences is reduced and the value of N₁ is maximized.

In some embodiments, parameters of the reference signal satisfy at least one of the following conditions:
being associated with an operating frequency band of the zero-power device;
being associated with a subcarrier spacing; or
being defined by a communication protocol.

In the case where the reference signal includes the first sequence group, the parameters of the reference signal include at least one of the length of the first synchronization sequence, the value of N₁, or the length of each time-domain unit corresponding to the first synchronization sequence.

In some embodiments, a higher frequency of the operating frequency band of the zero-power device indicates a larger frequency offset error range. Therefore, the parameters of the reference signal is adjusted based on the operating frequency band of the zero-power device to avoid an excessively large frequency offset error.

In some embodiments, channel specifications differ across different frequency bands. For example, a bandwidth of each channel in a 920 MHz frequency band is 250 kHz, and a guard interval between different channels is very small. Therefore, the frequency offset needs to be minimized to avoid interference to other channels.

In some embodiments, with different subcarrier spacing configurations, the parameters of the reference signal are different. A larger subcarrier spacing indicates a larger tolerable error range. Therefore, the parameters of the reference signal may be adjusted based on the size of the subcarrier spacing.

In some embodiments, the parameters of the reference signal are autonomously determined by the network device or defined by a communication protocol.

In S1820, the zero-power device receives the reference signal from the network device.

The first sequence group in the reference signal is or is not subjected to randomization processing.

In S1830, the zero-power device performs time-domain synchronization and frequency-domain synchronization based on the first sequence group.

The zero-power device performs envelope detection on the first sequence group to acquire an envelope detection result. The zero-power device performs the time-domain synchronization based on the envelope detection result of the first sequence group. The time-domain synchronization is also referred to as timing synchronization.

The zero-power device performs correlation detection on the first sequence group to acquire a correlation detection result. The zero-power device performs the frequency-domain synchronization based on the correlation detection result of the first sequence group. The frequency-domain synchronization is also referred to as frequency offset estimation.

In some embodiments, the first sequence group is a sequence group that has not been subjected to randomization processing. The zero-power device directly performs the correlation detection on the first sequence group to acquire the correlation detection result.

In some embodiments, the first sequence group is a sequence group that has been subjected to randomization processing. Prior to performing the correlation detection on the first sequence group, the zero-power device first multiplies the first sequence group by a conjugate of the pseudo-random sequence to acquire the first synchronization sequence repeated N₁ times corresponding to the first sequence group. The zero-power device performs the correlation detection on the first synchronization sequence repeated N₁ times to acquire the correlation detection result.

For a correlation detection method used in the embodiments of the present disclosure, reference may be made to correlation detection methods in some practices. That is, for a frequency offset estimation method used in the embodiments of the present disclosure, reference may be made to frequency offset estimation methods in some practices. For example, reference is made to a frequency offset estimation method based on an SSB in an NR system, or to a frequency offset estimation method based on a short training sequence (ST) and a long training sequence (LT) in a Wi-Fi system.

Exemplarily, the first synchronization sequence is a(i), the pseudo-random sequence is c(i), the first sequence group is a′(i), and the reference signal received by the zero-power device is r(i).

Then, r(i)=a′(i)*exp(j*α*i)=a(i)*c(i)*exp(j*α*i). exp(j**α*i) represents a frequency offset term to be estimated.

Then, upon receiving the reference signal, the zero-power device multiplies r(i) by conj(c(i)) to acquire a(i) and exp(j*α*i). conj(c(i)) represents the conjugate of c(i), and r(i)*conj(c(i)) is equivalent to r(i)/c(i).

It should be noted that, since the zero-power device needs to acquire the first sequence group using the pseudo-random sequence, the zero-power device needs to acquire the pseudo-random sequence.

In some embodiments, the pseudo-random sequence is defined by a communication protocol. Therefore, both the network device and the zero-power device know information of the pseudo-random sequence.

In some embodiments, the pseudo-random sequence is transmitted by the network device to the zero-power device. Therefore, both the network device and the zero-power device know information of the pseudo-random sequence.

In some embodiments, generation information of the pseudo-random sequence is transmitted by the network device to the zero-power device. Therefore, both the network device and the zero-power device may generate the pseudo-random sequence based on the generation information.

The frequency offset error α corresponding to the first sequence group may be calculated based on the phase angle. The phase angle refers to a phase angle between different first synchronization sequence groups. Each first synchronization sequence group includes at least two first synchronization sequences W.

Exemplarily, as illustrated in FIG. 14, the first sequence group corresponds to the first synchronization sequence W repeated N₁ times. A first first synchronization sequence W to an N₁^{th} first synchronization sequence W are used as a first first synchronization sequence group, and a second first synchronization sequence W to an (N₁+1)^{th} first synchronization sequence W are used as a second first synchronization sequence group.

The frequency offset error α is calculated with reference to Formula (1) and Formula (2) described above.

It should be understood that S1810 may be separately implemented as a signal transmission method performed by the network device. In this case, S1820 and S1830 are optional processes. S1820 may be separately implemented as a signal transmission method performed by the zero-power device. In this case, S1810 and S1830 are optional processes. S1830 may be separately implemented as a synchronization method performed by the zero-power device. In this case, S1820 and S1810 are optional steps. S1810 and S1820 may be implemented in combination as a reference signal transmission method. In this case, S1830 is an optional process. S1820 and S1830 may be implemented in combination as a signal transmission method and a synchronization method performed by the zero-power device. In this case, S1810 is an optional process.

In summary, in the method according to the embodiments of the present disclosure, the zero-power device performs time and frequency synchronization based on the reference signal from the network device to operate as much as possible on accurate time domain resources and frequency domain resources. In addition, the sequence group in the reference signal, the synchronization sequence, and the number of repetitions of the synchronization sequence are designed independently, such that the flexibility of the reference signal is significantly improved to satisfy the synchronization requirements in different scenarios. Moreover, the first sequence group carried in the reference signal is used for both time-domain synchronization and frequency-domain synchronization, such that time and frequency synchronization may be achieved in a case of consuming fewer transmission resources, thereby effectively improving synchronization efficiency and reducing resource consumption.

Next, an example in which the reference signal includes the second sequence group and the third sequence group is used to schematically describe the design and use of the reference signal.

FIG. 19 is a flowchart of a communication method for synchronization according to some exemplary embodiments of the present disclosure. The method is performed by a zero-power device and a network device. The method includes the following processes

In S1910, the network device transmits a reference signal, wherein the reference signal includes a second sequence group and a third sequence group.

The reference signal is used for time-domain synchronization and frequency-domain synchronization of the zero-power device.

The second sequence group is formed based on a second synchronization sequence or based on a second synchronization sequence repeated N₂ times, and N₂ is an integer greater than or equal to 1.

The second sequence group corresponds to at least one bit, that is, a bit length of the second sequence group is greater than or equal to 1. In some embodiments, each bit corresponds to at least one time-domain unit, or each bit corresponds to at least one sampling point.

In some embodiments, the second sequence group is formed based on the second synchronization sequence corresponding to the at least one time-domain unit. That is, the second synchronization sequence corresponds to a time-domain unit or a plurality of time-domain units, and the second sequence group corresponds to the second synchronization sequence repeated N₂ times.

In some embodiments, the second sequence group is formed based on the second synchronization sequence corresponding to the at least one sampling point. That is, the second synchronization sequence corresponds to a sampling point or a plurality of sampling points, and the second sequence group corresponds to the second synchronization sequence repeated N₂ times.

In some embodiments, the second sequence group is formed based on the second synchronization sequence corresponding to a portion of a time-domain unit. That is, the second synchronization sequence corresponds to the portion of the time-domain unit, and the second sequence group corresponds to the second synchronization sequence repeated N₂ times.

Exemplarily, the second sequence group corresponds to a second synchronization sequence W′, that is, the second sequence group corresponds to the second synchronization sequence W′.

Exemplarily, the second sequence group corresponds to a second synchronization sequence W′ repeated N₂ times, that is, the second sequence group corresponds to (N₂+1) repeated second synchronization sequences W′, as illustrated in FIG. 20.

The second synchronization sequence W′ corresponds to L′ bits. L′≥1. Each bit corresponds to at least one sampling point, or corresponds to at least one time-domain unit, or corresponds to a portion of a time-domain unit. In the case where the time-domain unit is a symbol, for example, each bit corresponds to at least one symbol; or each bit corresponds to a portion of a symbol. For example, each bit corresponds to 1/t of a symbol.

In some embodiments, different bits in the L′ bits correspond to the same number of sampling points or the same number of time-domain units.

In some embodiments, different bits in the L′ bits correspond to different numbers of sampling points or different numbers of time-domain units. Exemplarily, the second synchronization sequence W′ corresponds to three bits, the first bit corresponds to one sampling point, the second bit corresponds to three sampling points, and the third bit corresponds to two sampling points. Exemplarily, the second synchronization sequence W′ corresponds to eight bits, the first four bits correspond to two QPSK symbols, and the last four bits correspond to three QPSK symbols.

The third sequence group is formed based on a third synchronization sequence repeated N₃ times, and N₃ is an integer greater than or equal to 1.

The third sequence group corresponds to at least one bit, that is, a bit length of the third sequence group is greater than or equal to 1. In some embodiments, each bit corresponds to at least one time-domain unit, or each bit corresponds to at least one sampling point.

In some embodiments, the third sequence group is formed based on the third synchronization sequence corresponding to the at least one time-domain unit. That is, the third synchronization sequence corresponds to a time-domain unit or a plurality of time-domain units, and the third sequence group corresponds to the third synchronization sequence repeated N₃ times.

In some embodiments, the third sequence group is formed based on the third synchronization sequence corresponding to the at least one sampling point. That is, the third synchronization sequence corresponds to a sampling point or a plurality of sampling points, and the third sequence group corresponds to the third synchronization sequence repeated N₃ times.

In some embodiments, the third sequence group is formed based on the third synchronization sequence corresponding to a portion of a time-domain unit. That is, the third synchronization sequence corresponds to the portion of the time-domain unit, and the third sequence group corresponds to the third synchronization sequence repeated N₃ times.

Exemplarily, the third sequence group is illustrated in FIG. 9. The third sequence group corresponds to a third synchronization sequence G repeated N₃ times, that is, the third sequence group corresponds to (N₃+1) repeated third synchronization sequences G.

The third synchronization sequence G corresponds to q bits. q≥1. Each bit corresponds to at least one sampling point, or corresponds to at least one time-domain unit, or corresponds to a portion of a time-domain unit. In the case where the time-domain unit is a symbol, for example, each bit corresponds to at least one symbol; or each bit corresponds to a portion of a symbol. For example, each bit corresponds to 1/t of a symbol.

In some embodiments, different bits in the q bits correspond to the same number of sampling points or the same number of time-domain units.

In some embodiments, different bits in the q bits correspond to different numbers of sampling points or different numbers of time-domain units. Exemplarily, the third synchronization sequence G corresponds to three bits, the first bit corresponds to one sampling point, the second bit corresponds to three sampling points, and the third bit corresponds to two sampling points. Exemplarily, the third synchronization sequence G corresponds to eight bits, the first four bits correspond to two QPSK symbols, and the last four bits correspond to three QPSK symbols. Exemplarily, the third synchronization sequence G, as illustrated in FIG. 14, includes a third synchronization sequence A repeated three times and a third synchronization sequence B repeated once.

Furthermore, the time and frequency synchronization performance of the reference signal can be further improved or ensured in the following four aspects.

I. Considering the range of frequency offset estimation, the range of frequency offset estimation may be expanded by reducing the distance between two second synchronization sequences.

With reference to related content of the first sequence group described above, at least the following two modes are available for reducing the distance between two second synchronization sequences:

1. A value of L′ is reduced, that is, the number of bits corresponding to the second synchronization sequence W′ is reduced.

The value of L′ is minimized, so as to expand the range of frequency offset estimation as much as possible. Therefore, 1≤L′≤32.

2. A time-domain length corresponding to each bit is reduced.

For example, the number of sampling points corresponding to each bit is reduced, or the length of the time-domain unit corresponding to each bit is reduced. The length of the time-domain unit may be expressed in time, or may be represented by the number of sampling points.

Exemplarily, a symbol corresponds to N_{fft}+N_{cp} sampling points. N_{fft} represents a corresponding number of sampling points upon an FFT, and N_{cp} represents a number of sampling points corresponding to a CP.

Then, the time-domain length corresponding to each bit may be reduced by reducing N_{c}p or reducing a length of a data portion.

II. Considering the range of frequency offset estimation, the range of frequency offset estimation is expanded by reducing the distance between two third synchronization sequences.

With reference to related content of the first sequence group described above, at least the following two modes are available for reducing the distance between two third synchronization sequences.

1. A value of q is reduced, that is, the number of bits corresponding to the third synchronization sequence G is reduced.

The value of q is minimized, so as to expand the range of frequency offset estimation as much as possible. Therefore, 1≤q≤32.

2. A time-domain length corresponding to each bit is reduced.

For example, the number of sampling points corresponding to each bit is reduced, or the length of the time-domain unit corresponding to each bit is reduced. The length of the time-domain unit may be expressed in time, or may be represented by the number of sampling points.

Exemplarily, a symbol corresponds to N_{fft}+N_{cp} sampling points. N_{fft} represents a corresponding number of sampling points upon an FFT, and N_{cp} represents a number of sampling points corresponding to a CP.

Then, the time-domain length corresponding to each bit may be reduced by reducing N_{c}p or reducing a length of a data portion.

It should be understood that mode 1 and mode 2 may be used separately, or may be used in combination. For example, both the length of the synchronization sequence and the time-domain length corresponding to each bit are reduced. It should be understood that the reduction of N_{cp} and the reduction of the length of the data portion may be used separately, or may be used in combination. For example, both N_{cp} and the length of the data portion are reduced.

III. Considering the performance of time and frequency synchronization, the value of N₂ may be maximized to improve the performance of time-domain synchronization and frequency-domain synchronization.

IV. Considering the performance of time and frequency synchronization, the value of N₃ may be maximized to improve the performance of time-domain synchronization and frequency-domain synchronization.

However, larger values of N₂ and N₃ indicate a larger amount of data that needs to be cached and processed by the zero-power device. In the case where the values of N₂ and N₃ are excessively large, storage, power consumption, or the like of the zero-power device may be adversely affected. Therefore, 1≤N₂≤31 and/or 1≤N₃≤31.

It should be understood that the above four aspects may be used separately, or may be used in combination.

Any two of the above four aspects may be used in combination. For example, the distance between two second synchronization sequences is reduced and the value of N₂ is maximized. For example, the distance between two third synchronization sequences is reduced and the value of N₃ is maximized. For example, the distance between two second synchronization sequences is reduced and the distance between two third synchronization sequences is reduced. For example, the value of N₂ is maximized and the value of N₃ is maximized. For example, the distance between two second synchronization sequences is reduced and the value of N₃ is maximized. For example, the value of N₂ is maximized and the distance between two third synchronization sequences is reduced.

Any three of the above four aspects may be used in combination. For example, the distance between two second synchronization sequences is reduced, the value of N₂ is maximized, and the distance between two third synchronization sequences is reduced. For example, the distance between two second synchronization sequences is reduced, the value of N₂ is maximized, and the value of N₃ is maximized. For example, the distance between two second synchronization sequences is reduced, the distance between two third synchronization sequences is reduced, and the value of N₃ is maximized. For example, the value of N₂ is maximized, the distance between two third synchronization sequences is reduced, and the value of N₃ is maximized.

The above four aspects may be used in combination. The distance between two third synchronization sequences is reduced, the value of N₃ is maximized, the distance between two second synchronization sequences is reduced, and the value of N₂ is maximized.

Exemplarily, in the case where L′=32 and N₂=1, the bit length of the second synchronization sequence W′ is 32, that is, the second synchronization sequence W′ corresponds to 32 bits or bit positions. Moreover, the second sequence group is formed based on the second synchronization sequence W′ repeated once, that is, the second sequence group corresponds to two repeated second synchronization sequences W′.

Exemplarily, in the case where q=4 and N₃=8, the bit length of the third synchronization sequence G is 4, that is, the third synchronization sequence G corresponds to four bits or bit positions. Moreover, the third sequence group is formed based on the third synchronization sequence G repeated eight times, that is, the third sequence group corresponds to nine repeated third synchronization sequences G.

Furthermore, considering that the repeated synchronization sequences may cause the frequency points corresponding to the sequence group to be too concentrated, resulting in a high energy impact in the vicinity of the central frequency point, which violates certain spectrum regulations and is detrimental to the synchronization performance, in the embodiments of the present disclosure, randomization processing (or referred to as randomizing processing) may be further performed on the second synchronization sequence W′ and the third synchronization sequence G, such that the energy distribution of the second sequence group and the third sequence group becomes more uniform in the frequency domain. For a randomization processing mode, reference is made to the foregoing descriptions, which are not repeated herein.

Exemplarily, Y second partial sequences in the non-repeated second synchronization sequence W′ are multiplied by Y sequence elements in a pseudo-random sequence to acquire the second sequence group. Therefore, it may be considered that the second sequence group is a randomized sequence group formed based on the second synchronization sequence W′. Exemplarily, the pseudo-random sequence includes sequence elements with values of +1 and −1, or includes sequence elements with values of +j and −j, or includes sequence elements with values of +1, −1, +j, and −j.

Exemplarily, the second synchronization sequence W′ repeated N₂ times is multiplied by (N₂+1) sequence elements in a pseudo-random sequence to acquire the second sequence group. Therefore, it may be considered that the second sequence group is a randomized sequence group formed based on the second synchronization sequence W repeated N₂ times.

Exemplarily, the third synchronization sequence G repeated N₃ times is multiplied by (N₃+1) sequence elements in a pseudo-random sequence to acquire the third sequence group. Therefore, it may be considered that the third sequence group is a randomized sequence group formed based on the third synchronization sequence G repeated N₃ times.

In some embodiments, parameters of the reference signal satisfy at least one of the following conditions:
being associated with an operating frequency band of the zero-power device;
being associated with a subcarrier spacing; or
being defined by a communication protocol.

In the case where the reference signal includes the second sequence group and the third sequence group, the parameters of the reference signal include at least one of the length of the second synchronization sequence, the value of N₂, the length of each time-domain unit corresponding to the second synchronization sequence, the length of the third synchronization sequence, the value of N₃, or the length of each time-domain unit corresponding to the third synchronization sequence.

In some embodiments, a higher frequency of the operating frequency band of the zero-power device indicates a larger frequency offset error range. Therefore, the parameters of the reference signal is adjusted based on the operating frequency band of the zero-power device to avoid an excessively large frequency offset error.

In some embodiments, channel specifications differ across different frequency bands. For example, a bandwidth of each channel in a 920 MHz frequency band is 250 kHz, and a guard interval between different channels is very small. Therefore, the frequency offset needs to be minimized to avoid interference to other channels.

In some embodiments, with different subcarrier spacing configurations, the parameters of the reference signal are different. A larger subcarrier spacing indicates a larger tolerable error range. Therefore, the parameters of the reference signal may be adjusted based on the size of the subcarrier spacing.

In some embodiments, the parameters of the reference signal are autonomously determined by the network device or defined by a communication protocol.

In S1920, the zero-power device receives the reference signal from the network device.

The second sequence group and the third sequence group in the reference signal are or are not subjected to randomization processing.

In S1930, the zero-power device performs time-domain synchronization and frequency-domain synchronization based on the second sequence group and the third sequence group.

The zero-power device performs envelope detection on the second sequence group to acquire an envelope detection result. The zero-power device performs the time-domain synchronization based on the envelope detection result of the second sequence group. The time-domain synchronization is also referred to as timing synchronization.

The zero-power device performs correlation detection on the third sequence group to acquire a correlation detection result. The zero-power device performs the frequency-domain synchronization based on the correlation detection result of the third sequence group. The frequency-domain synchronization is also referred to as frequency offset estimation.

In some embodiments, the reference signal has not been subjected to randomization processing. The zero-power device directly performs the correlation detection on the third sequence group in the reference signal to acquire the correlation detection result.

In some embodiments, the reference signal is subjected to randomization processing. Prior to performing the correlation detection on the third sequence group, the zero-power device first multiplies the third sequence group by a conjugate of the pseudo-random sequence to acquire the first synchronization sequence repeated N₃ times corresponding to the third sequence group. The zero-power device performs the correlation detection on the first synchronization sequence repeated N₃ times to acquire the correlation detection result.

For a correlation detection method used in the embodiments of the present disclosure, reference may be made to correlation detection methods in some practices. That is, for a frequency offset estimation method used in the embodiments of the present disclosure, reference may be made to frequency offset estimation methods in some practices. For example, reference is made to a frequency offset estimation method based on an SSB in an NR system, or to a frequency offset estimation method based on an ST and an LT in a Wi-Fi system.

Exemplarily, the second synchronization sequence is a(i), the pseudo-random sequence corresponding to the second synchronization sequence is c(i), the second sequence group is a′(i), the third synchronization sequence is b(i), the pseudo-random sequence corresponding to the third synchronization sequence is c′(i), the third sequence group is b′ (i), and the reference signal received by the zero-power device is r(i).

Then, r(i)=(a′(i)+b′(i))*exp(j*α*i)=(a(i)*c(i)+b(i)*c′(i))*exp(j*α*i). exp(j*α*i) represents a frequency offset term to be estimated.

Then, upon receiving the reference signal, the zero-power device multiplies r(i) by conj(c(i)) to acquire a(i), b(i), and exp(j*α*i). conj(c(i)) represents the conjugate of c(i), and r(i)*conj(c(i)) is equivalent to r(i)/c(i).

It should be noted that, since the zero-power device needs to acquire the second sequence group and the third sequence group using the pseudo-random sequence, the zero-power device needs to acquire the pseudo-random sequence.

In some embodiments, the pseudo-random sequence is defined by a communication protocol. Therefore, both the network device and the zero-power device know information of the pseudo-random sequence.

In some embodiments, the pseudo-random sequence is transmitted by the network device to the zero-power device. Therefore, both the network device and the zero-power device know information of the pseudo-random sequence.

In some embodiments, generation information of the pseudo-random sequence is transmitted by the network device to the zero-power device. Therefore, both the network device and the zero-power device may generate the pseudo-random sequence based on the generation information.

The frequency offset error α corresponding to the third sequence group may be calculated based on the phase angle. The phase angle refers to a phase angle between different third synchronization sequence groups. Each third synchronization sequence group includes at least two third synchronization sequences G.

Exemplarily, as illustrated in FIG. 13, the third sequence group corresponds to the third synchronization sequence G repeated N₃ times. A first third synchronization sequence G to an N₃^{th} third synchronization sequence G are used as a first third synchronization sequence group, and a second third synchronization sequence G to an (N₃+1)^{th} third synchronization sequence G are used as a second third synchronization sequence group.

The frequency offset error α is calculated with reference to Formula (1) and Formula (2) described above.

It should be understood that S1910 may be separately implemented as a signal transmission method performed by the network device. In this case, S1920 and S1930 are optional processes. S1920 may be separately implemented as a signal transmission method performed by the zero-power device. In this case, S1910 and S1930 are optional processes. S1930 may be separately implemented as a synchronization method performed by the zero-power device. In this case, S1920 and S1910 are optional processes. S1910 and S1920 may be implemented in combination as a reference signal transmission method. In this case, S1930 is an optional process. S1920 and S1930 may be implemented in combination as a signal transmission method and a synchronization method performed by the zero-power device. In this case, S1910 is an optional process.

In summary, in the method according to the embodiments of the present disclosure, the zero-power device performs time and frequency synchronization based on the reference signal from the network device to operate as much as possible on accurate time domain resources and frequency domain resources. In addition, the sequence group in the reference signal, the synchronization sequence, and the number of repetitions of the synchronization sequence are designed independently, such that the flexibility of the reference signal is significantly improved to satisfy the synchronization requirements in different scenarios. Moreover, the second sequence group and the third sequence group carried in the reference signal are used for time-domain synchronization and frequency-domain synchronization, such that information of the time-domain synchronization and information of the frequency-domain synchronization are independent of each other, which helps the zero-power device perform more accurate and proper time-domain synchronization and frequency-domain synchronization. In addition, the design of the second sequence group and the third sequence group allows the network device to separately adjust the information of the time-domain synchronization or the information of the frequency-domain synchronization, thereby further improving the flexibility of the reference signal.

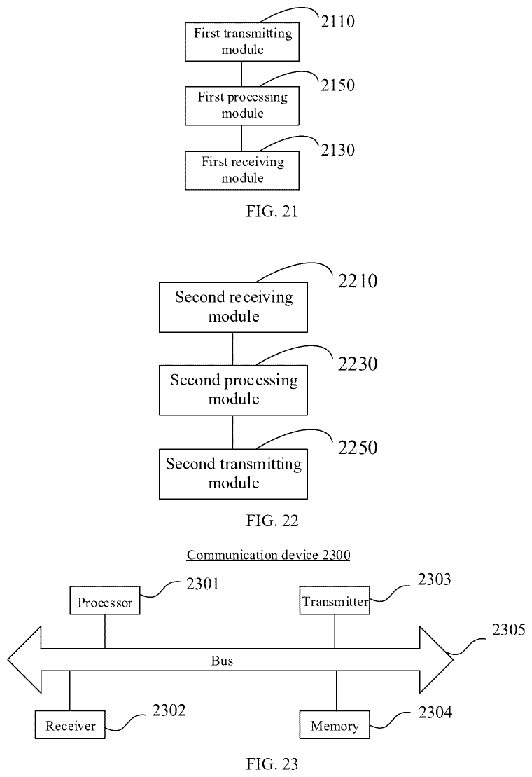

FIG. 21 is a structural block diagram of a communication apparatus for synchronization according to some exemplary embodiments of the present disclosure. The apparatus may be implemented as a network device or a part of the network device by software, hardware, or a combination thereof. The apparatus includes at least part of a first transmitting module 2110, a first receiving module 2130, or a first processing module 2150.

The first transmitting module 2110 is configured to transmit a reference signal, where the reference signal is used for time-domain synchronization and frequency-domain synchronization of a zero-power device; and the reference signal includes at least one sequence group, wherein the at least one sequence group is formed based on a synchronization sequence repeated N times, and N is an integer greater than or equal to 1.

In some embodiments, the at least one sequence group corresponds to at least one bit, wherein each of the at least one bit corresponds to at least one time-domain unit or at least one sampling point.

In some embodiments, the at least one sequence group is formed based on at least one of:
a synchronization sequence corresponding to the at least one time-domain unit;
a synchronization sequence corresponding to the at least one sampling point; or
a synchronization sequence corresponding to a portion of one time-domain unit.

In some embodiments, the sequence group includes a first sequence group, wherein the first sequence group is formed based on a first synchronization sequence repeated N₁ times, and N₁ is an integer greater than or equal to 1.

In some embodiments, the first sequence group is acquired by performing randomization processing on the first synchronization sequence repeated N₁ times.

In some embodiments, the first sequence group is acquired by multiplying the first synchronization sequence repeated N₁ times by a pseudo-random sequence, wherein the first synchronization sequence repeated N₁ times is in one-to-one correspondence with sequence elements in the pseudo-random sequence; or
the first synchronization sequence repeated N₁ times includes Y₁ first partial sequences, and the first sequence group is acquired by multiplying the Y₁ first partial sequences by a pseudo-random sequence, wherein the Y₁ first partial sequences are in one-to-one correspondence with sequence elements in the pseudo-random sequence, and Y₁ is greater than or equal to (N₁+1); or
the first synchronization sequence repeated N₁ times includes Z₁ first partial sequence groups, and the first sequence group is acquired by multiplying the Z₁ first partial sequence groups by a pseudo-random sequence, wherein the Z₁ first partial sequence groups are in one-to-one correspondence with sequence elements in the pseudo-random sequence, each of the Z₁ first partial sequence groups includes at least one first partial sequence, and Z₁ is greater than or equal to (N₁+1).

In some embodiments, the sequence group includes a second sequence group and a third sequence group, wherein
the second sequence group is formed based on a second synchronization sequence or based on a second synchronization sequence repeated N₂ times, and N₂ is an integer greater than or equal to 1; and
the third sequence group is formed based on a third synchronization sequence repeated N₃ times, and N₃ is an integer greater than or equal to 1.

In some embodiments, the second sequence group is acquired by performing randomization processing on the second synchronization sequence or the second synchronization sequence repeated N₂ times; and
the third sequence group is acquired by performing randomization processing on the third synchronization sequence repeated N₃ times.

In some embodiments, the second synchronization sequence includes at least one second partial sequence, and the second sequence group is acquired by multiplying the at least one second partial sequence by a pseudo-random sequence, wherein the at least one second partial sequence is in one-to-one correspondence with sequence elements in the pseudo-random sequence; or
the second synchronization sequence includes at least one second partial sequence group, and the second sequence group is acquired by multiplying the at least one second partial sequence group by a pseudo-random sequence, wherein the at least one second partial sequence group is in one-to-one correspondence with sequence elements in the pseudo-random sequence, and each of the at least one second partial sequence group includes at least one second partial sequence; or
the second sequence group is acquired by multiplying the second synchronization sequence repeated N₂ times by a pseudo-random sequence, wherein the second synchronization sequence repeated N₂ times is in one-to-one correspondence with sequence elements in the pseudo-random sequence; or
the second synchronization sequence repeated N₂ times includes Y₂ second partial sequences, and the second sequence group is acquired by multiplying the Y₂ second partial sequences by a pseudo-random sequence, wherein the Y₂ second partial sequences are in one-to-one correspondence with sequence elements in the pseudo-random sequence, and Y₂ is greater than or equal to (N₂+1); or
the second synchronization sequence repeated N₂ times includes Z₂ second partial sequence groups, and the second sequence group is acquired by multiplying the Z₂ second partial sequence groups by a pseudo-random sequence, wherein the Z₂ second partial sequence groups are in one-to-one correspondence with sequence elements in the pseudo-random sequence, each of the Z₂ second partial sequence groups includes at least one second partial sequence, and Z₂ is greater than or equal to (N₂+1).

In some embodiments, the third sequence group is acquired by multiplying the third synchronization sequence repeated N₃ times by a pseudo-random sequence, wherein the third synchronization sequence repeated N₃ times is in one-to-one correspondence with sequence elements in the pseudo-random sequence; or
the third synchronization sequence repeated N₃ times includes Y₃ third partial sequences, and the third sequence group is acquired by multiplying the Y₃ third partial sequences by a pseudo-random sequence, wherein the Y₃ third partial sequences are in one-to-one correspondence with sequence elements in the pseudo-random sequence, and Y₃ is greater than or equal to (N₃+1); or
the third synchronization sequence repeated N₃ times includes Z₃ third partial sequence groups, and the third sequence group is acquired by multiplying the Z₃ third partial sequence groups by a pseudo-random sequence, wherein the Z₃ third partial sequence groups are in one-to-one correspondence with sequence elements in the pseudo-random sequence, each of the Z₃ third partial sequence groups includes at least one third partial sequence, and Z₃ is greater than or equal to (N₃+1).

In some embodiments, parameters of the reference signal satisfy at least one of following conditions:
being associated with an operating frequency band of the zero-power device;
being associated with a subcarrier spacing; or
being defined by a communication protocol,
wherein the parameters of the reference signal include at least one of a length of the synchronization sequence, a value of N, or a length of each time-domain unit corresponding to the synchronization sequence.

In some embodiments, the apparatus further includes the first receiving module 2130, configured to receive signals or data from the zero-power device. For example, the first receiving module 2130 is configured to receive a synchronization request from the zero-power device. For example, the first receiving module 2130 is configured to receive backscattering signals from the zero-power device. For example, the first receiving module 2130 is configured to receive signals or data from a primary transmitter of the zero-power device.

In some embodiments, the apparatus further includes the first processing module 2150, configured to generate the reference signal. For example, the first processing module 2150 is configured to perform randomization processing on the first synchronization sequence repeated N₁ times to acquire the first sequence group. For example, the first processing module 2150 is configured to perform randomization processing on the second synchronization sequence to acquire the second sequence group. For example, the first processing module 2150 is configured to perform randomization processing on the second synchronization sequence repeated N₂ times to acquire the second sequence group. For example, the first processing module 2150 is configured to perform randomization processing on the third synchronization sequence repeated N₃ times to acquire the third sequence group.

In some embodiments, the first processing module 2150 is further configured to determine the parameters of the reference signal.

In some embodiments, the first processing module 2150 is further configured to determine the parameters of the reference signal based on at least one of the operating frequency band of the zero-power device, the subcarrier spacing, or the communication protocol.

In some embodiments, the apparatus according to the embodiments of the present disclosure includes one first transmitting module 2110. The first transmitting module 2110 supports performing all the transmission processes performed by the network device in the above embodiments, such as S610, S1810, and S1910.

In some embodiments, the apparatus according to the embodiments of the present disclosure includes a plurality of first transmitting modules 2110. The plurality of first transmitting modules 2110 respectively support performing part of the transmission performed by the network device in the above embodiments.

In some embodiments, the processes performed by different first transmitting modules 2110 are completely the same, partially the same, or completely different.

In some embodiments, the apparatus according to the embodiments of the present disclosure includes one first processing module 2150. The first processing module 2150 supports performing all the processes related to processing, all the processes related to generation, and all the processes related to determination, which are performed by the network device in the above embodiments.

In some embodiments, the apparatus according to the embodiments of the present disclosure includes a plurality of first processing modules 2150. The plurality of first processing modules 2150 respectively support performing part of the processes related to processing, part of the processes related to determination, and part of the processes related to generation, which are performed by the network device in the above embodiments.

In some embodiments, the processes performed by different first processing modules 2150 are completely the same, partially the same, or completely different.

In some embodiments, the apparatus according to the embodiments of the present disclosure includes one first receiving module 2130. The first receiving module 2130 supports performing all the reception processes performed by the network device in the above embodiments.

In some embodiments, the apparatus according to the embodiments of the present disclosure includes a plurality of first receiving modules 2130. The plurality of first receiving modules 2130 respectively support performing part of the reception processes performed by the network device in the above embodiments.

In some embodiments, the processes performed by different first receiving modules 2130 are completely the same, partially the same, or completely different.

In summary, in the apparatus according to the embodiments of the present disclosure, the reference signal formed based on the synchronization sequence repeated N times is used for time and frequency synchronization, and the reference signal is transmitted by the network device, such that the zero-power device performs time and frequency synchronization based on the reference signal to operate as much as possible on accurate time domain resources and frequency domain resources. In addition, the sequence group in the reference signal, the synchronization sequence, and the number of repetitions of the synchronization sequence are designed independently, such that the flexibility of the reference signal is significantly improved to satisfy the synchronization requirements in different scenarios.

FIG. 22 is a block diagram of a communication apparatus for synchronization according to some exemplary embodiments of the present disclosure. The apparatus may be implemented as a zero-power device or a part of the zero-power device by software, hardware, or a combination thereof. The apparatus includes a second receiving module 2210, a second processing module 2230, and a second transmitting module 2250.

The second receiving module 2210 is configured to receive a reference signal, wherein the reference signal is used for time-domain synchronization and frequency-domain synchronization of the apparatus; and the reference signal includes at least one sequence group, wherein the at least one sequence group is formed based on a synchronization sequence repeated N times, and N is an integer greater than or equal to 1.

In some embodiments, the at least one sequence group corresponds to at least one bit, wherein each of the at least one bit corresponds to at least one time-domain unit or at least one sampling point.

In some embodiments, the at least one sequence group is formed based on at least one of:
a synchronization sequence corresponding to the at least one time-domain unit;
a synchronization sequence corresponding to the at least one sampling point; or
a synchronization sequence corresponding to a portion of one time-domain unit.

In some embodiments, the sequence group includes a first sequence group, wherein the first sequence group is formed based on a first synchronization sequence repeated N₁ times, and N₁ is an integer greater than or equal to 1.

In some embodiments, the first sequence group is acquired by performing randomization processing on the first synchronization sequence repeated N₁ times.

In some embodiments, the first sequence group is acquired by multiplying the first synchronization sequence repeated N₁ times by a pseudo-random sequence, wherein the first synchronization sequence repeated N₁ times is in one-to-one correspondence with sequence elements in the pseudo-random sequence; or
the first synchronization sequence repeated N₁ times includes Y₁ first partial sequences, and the first sequence group is acquired by multiplying the Y₁ first partial sequences by a pseudo-random sequence, wherein the Y₁ first partial sequences are in one-to-one correspondence with sequence elements in the pseudo-random sequence, and Y₁ is greater than or equal to (N₁+1); or
the first synchronization sequence repeated N₁ times includes Z₁ first partial sequence groups, and the first sequence group is acquired by multiplying the Z₁ first partial sequence groups by a pseudo-random sequence, wherein the Z₁ first partial sequence groups are in one-to-one correspondence with sequence elements in the pseudo-random sequence, each of the Z₁ first partial sequence groups includes at least one first partial sequence, and Z₁ is greater than or equal to (N₁+1).

In some embodiments, the sequence group includes a second sequence group and a third sequence group, wherein
the second sequence group is formed based on a second synchronization sequence or based on a second synchronization sequence repeated N₂ times, and N₂ is an integer greater than or equal to 1; and
the third sequence group is formed based on a third synchronization sequence repeated N₃ times, and N₃ is an integer greater than or equal to 1.

In some embodiments, the second sequence group is acquired by performing randomization processing on the second synchronization sequence or the second synchronization sequence repeated N₂ times; and
the third sequence group is acquired by performing randomization processing on the third synchronization sequence repeated N₃ times.

In some embodiments, the second synchronization sequence includes at least one second partial sequence, and the second sequence group is acquired by multiplying the at least one second partial sequence by a pseudo-random sequence, wherein the at least one second partial sequence is in one-to-one correspondence with sequence elements in the pseudo-random sequence; or
the second synchronization sequence includes at least one second partial sequence group, and the second sequence group is acquired by multiplying the at least one second partial sequence group by a pseudo-random sequence, wherein the at least one second partial sequence group is in one-to-one correspondence with sequence elements in the pseudo-random sequence, and each of the at least one second partial sequence group includes at least one second partial sequence; or
the second sequence group is acquired by multiplying the second synchronization sequence repeated N₂ times by a pseudo-random sequence, wherein the second synchronization sequence repeated N₂ times is in one-to-one correspondence with sequence elements in the pseudo-random sequence; or
the second synchronization sequence repeated N₂ times includes Y₂ second partial sequences, and the second sequence group is acquired by multiplying the Y₂ second partial sequences by a pseudo-random sequence, wherein the Y₂ second partial sequences are in one-to-one correspondence with sequence elements in the pseudo-random sequence, and Y₂ is greater than or equal to (N₂+1); or
the second synchronization sequence repeated N₂ times includes Z₂ second partial sequence groups, and the second sequence group is acquired by multiplying the Z₂ second partial sequence groups by a pseudo-random sequence, wherein the Z₂ second partial sequence groups are in one-to-one correspondence with sequence elements in the pseudo-random sequence, each of the Z₂ second partial sequence groups includes at least one second partial sequence, and Z₂ is greater than or equal to (N₂+1).

In some embodiments, the third sequence group is acquired by multiplying the third synchronization sequence repeated N₃ times by a pseudo-random sequence, wherein the third synchronization sequence repeated N₃ times is in one-to-one correspondence with sequence elements in the pseudo-random sequence; or
the third synchronization sequence repeated N₃ times includes Y₃ third partial sequences, and the third sequence group is acquired by multiplying the Y₃ third partial sequences by a pseudo-random sequence, wherein the Y₃ third partial sequences are in one-to-one correspondence with sequence elements in the pseudo-random sequence, and Y₃ is greater than or equal to (N₃+1); or
the third synchronization sequence repeated N₃ times includes Z₃ third partial sequence groups, and the third sequence group is acquired by multiplying the Z₃ third partial sequence groups by a pseudo-random sequence, wherein the Z₃ third partial sequence groups are in one-to-one correspondence with sequence elements in the pseudo-random sequence, each of the Z₃ third partial sequence groups includes at least one third partial sequence, and Z₃ is greater than or equal to (N₃+1).

In some embodiments, the apparatus further includes the second processing module 2230, configured to perform the time-domain synchronization and the frequency-domain synchronization based on the reference signal.

In some embodiments, the second processing module 2230 is further configured to: perform the time-domain synchronization based on an envelope detection result of the first sequence group; and perform the frequency-domain synchronization based on a correlation detection result of the first sequence group.

In some embodiments, the second processing module 2230 is further configured to perform envelope detection on the first sequence group.

In some embodiments, the second processing module 2230 is further configured to perform correlation detection on the first sequence group.

In some embodiments, the second processing module 2230 is further configured to multiply the first sequence group by a conjugate of the pseudo-random sequence to acquire the first synchronization sequence.

In some embodiments, the second processing module 2230 is further configured to: perform the time-domain synchronization based on an envelope detection result of the second sequence group; and perform the frequency-domain synchronization based on a correlation detection result of the third sequence group.

In some embodiments, the second processing module 2230 is further configured to perform envelope detection on the second sequence group.

In some embodiments, the second processing module 2230 is further configured to perform correlation detection on the third sequence group.

In some embodiments, the second processing module 2230 is further configured to multiply the third sequence group by a conjugate of the pseudo-random sequence to acquire the third synchronization sequence.

In some embodiments, parameters of the reference signal satisfy at least one of following conditions:
being associated with an operating frequency band of the zero-power device;
being associated with a subcarrier spacing; or
being defined by a communication protocol,
wherein the parameters of the reference signal include at least one of a length of the synchronization sequence, a value of N, or a length of each time-domain unit corresponding to the synchronization sequence.

In some embodiments, the apparatus further includes the second transmitting module 2250, configured to transmit signals and/or data.

In some embodiments, the second transmitting module 2250 is implemented as a primary transmitter.

In some embodiments, the second transmitting module 2250 is implemented as a backscattering transmitter.

In some embodiments, the first receiving module 2210 is implemented as a primary receiver.

In some embodiments, the first receiving module 2210 is implemented as a wake up receiver.

In some embodiments, the apparatus according to the embodiments of the present disclosure includes one second transmitting module 2250. The second transmitting module 2250 supports performing all the transmission processes performed by the zero-power device in the above embodiments.

In some embodiments, the apparatus according to the embodiments of the present disclosure includes a plurality of second transmitting modules 2250. The plurality of second transmitting modules 2250 respectively support performing part of the transmission processes performed by the zero-power device in the above embodiments.

In some embodiments, the processes performed by different second transmitting modules 2250 are completely the same, partially the same, or completely different.

In some embodiments, the apparatus according to the embodiments of the present disclosure includes one second processing module 2230. The second processing module 2230 supports performing all the processes related to processing, all the processes related to generation, and all the processes related to determination, which are performed by the zero-power device in the above embodiments, such as S1830 and S1930.

In some embodiments, the apparatus according to the embodiments of the present disclosure includes a plurality of second processing modules 2230. The plurality of second processing modules 2230 respectively support performing part of the processes related to processing, part of the processes related to determination, and part of the processes related to generation, which are performed by the zero-power device in the above embodiments.

In some embodiments, the processes performed by different second processing modules 2230 are completely the same, partially the same, or completely different.

In some embodiments, the apparatus according to the embodiments of the present disclosure includes one second receiving module 2210. The second receiving module 2210 supports performing all the reception processes performed by the zero-power device in the above embodiments, such as S710, S1820, and S1920.

In some embodiments, the apparatus according to the embodiments of the present disclosure includes a plurality of second receiving modules 2210. The plurality of second receiving modules 2210 respectively support performing part of the reception processes performed by the zero-power device in the above embodiments.

In some embodiments, the processes performed by different second receiving modules 2210 are completely the same, partially the same, or completely different.

In summary, in the apparatus according to the embodiments of the present disclosure, the reference signal formed based on the synchronization sequence repeated N times is used for time and frequency synchronization, and the reference signal is transmitted by the network device, such that the zero-power device performs time and frequency synchronization based on the reference signal to operate as much as possible on accurate time domain resources and frequency domain resources. In addition, the sequence group in the reference signal, the synchronization sequence, and the number of repetitions of the synchronization sequence are designed independently, such that the flexibility of the reference signal is significantly improved to satisfy the synchronization requirements in different scenarios.

FIG. 23 is a schematic structural diagram of a communication device 2300 (including a zero-power device and/or a network device) according to some exemplary embodiments of the present disclosure. The communication device includes: a processor 2301, a receiver 2302, a transmitter 2303, a memory 2304, and a bus 2305.

The processor 2301 includes one or more processing cores, and the processor 2301 executes various functional applications and performs information processing by running software programs and modules.

The receiver 2302 and the transmitter 2303 are implemented as a communication assembly, which may be a communication chip and may be referred to as a transceiver. In some embodiments, the receiver 2302 is configured to implement the functions and processes of the first receiving module 2130 and/or the second receiving module 2210 as described above, and the transmitter 2303 is configured to implement the functions and processes of the first transmitting module 2110 and/or the second transmitting module 2250 as described above.

The memory 2304 is connected to the processor 2301 by the bus 2305.

The memory 2304 is configured to store at least one instruction, and the processor 2301 is configured to execute the at least one instruction to perform the processes in the above method embodiments. The processor 2301 is configured to implement the functions and processes of the first processing module 2150 and/or the second processing module 2230 as described above.

In addition, the memory 2304 may be implemented by any type or combination of volatile or non-volatile storage devices including, but not limited to: magnetic or optical disks, electrically-erasable programmable read-only memories (EEPROMs), erasable programmable read-only memories (EPROMs), static random access memories (SRAMs), read-only memories (ROMs), magnetic memories, flash memories, and programmable read-only memories (PROMs).

In some embodiments, the receiver 2302 independently receives signals/data, or the processor 2301 controls the receiver 2302 to receive signals/data, or the processor 2301 requests the receiver 2302 to receive signals/data, or the processor 2301 cooperates with the receiver 2302 to receive signals/data.

In some embodiments, the transmitter 2303 independently transmits signals/data, or the processor 2301 controls the transmitter 2303 to transmit signals/data, or the processor 2301 requests the transmitter 2303 to transmit signals/data, or the processor 2301 cooperates with the transmitter 2303 to transmit signals/data.

In some embodiments, the processor 2301 and the receiver 2302 are implemented as a module, or the processor 2301 is implemented as a part of the receiver 2302.

In some embodiments, the receiver 2302 is implemented as a receiver unit. In some embodiments, the receiver includes or does not include the processor 2301.

In some embodiments, the processor 2301 and the transmitter 2303 are implemented as one module, or the processor 2301 is implemented as a part of the transmitter 2303.

In some embodiments, the transmitter 2303 is implemented as a transmitter unit. In some embodiments, the receiver includes or does not include the processor 2301.

In some exemplary embodiments of the present disclosure, a computer-readable storage medium is further provided. The computer-readable storage medium stores at least one program. The at least one program, when loaded and run by the processor, causes the processor to perform the communication method for synchronization according to the above method embodiments.

In some exemplary embodiments of the present disclosure, a chip is further provided. The chip includes programmable logic circuitry and/or one or more program instructions. The chip, when running, is caused to perform the communication method for synchronization according to the above method embodiments.

In some exemplary embodiments of the present disclosure, a computer program product is further provided. The computer program product, when running on a processor of a computer device, causes the computer device to perform the above communication method for synchronization.

In some exemplary embodiments of the present disclosure, a computer program is further provided. The computer program includes one or more computer instructions. The one or more computer instructions, when loaded and executed by a processor of a computer device, cause the computer device to perform the above communication method for synchronization.

Those skilled in the art should understand that all or part of the processes in the above embodiments may be completed by hardware or by relevant hardware instructed by programs. The programs are stored in a computer-readable storage medium, which may be a ROM, a magnetic disk or an optical disk.

Described above are merely optional embodiments of the present disclosure and are not intended to limit the present disclosure. Any modifications, equivalent substitutions, improvements, and the like, made within the spirit and principle of the present disclosure should fall within the protection scope of the present disclosure.

1. A communication method for synchronization, applicable to zero-power communication and performed by a network device, the method comprising:
transmitting a reference signal, wherein the reference signal is used for time-domain synchronization and frequency-domain synchronization of a zero-power device, and the reference signal comprises at least one sequence group, wherein the at least one sequence group is formed based on a synchronization sequence repeated N times, N being an integer greater than or equal to 1.

2. The method according to claim 1, wherein the at least one sequence group corresponds to at least one bit, wherein each of the at least one bit corresponds to at least one time-domain unit or at least one sampling point.

3. The method according to claim 1, wherein the at least one sequence group is formed based on at least one of:
a synchronization sequence corresponding to at least one time-domain unit;
a synchronization sequence corresponding to at least one sampling point; or
a synchronization sequence corresponding to a portion of one of the at least one time-domain unit.

4. The method according to claim 1, wherein the at least one sequence group comprises a first sequence group, wherein the first sequence group is formed based on a first synchronization sequence repeated N₁ times, N₁ being an integer greater than or equal to 1.

5. The method according to claim 4, wherein the first sequence group is acquired by performing randomization processing on the first synchronization sequence repeated N₁ times.

6. The method according to claim 5, wherein
the first sequence group is acquired by multiplying the first synchronization sequence repeated N₁ times by a pseudo-random sequence, wherein the first synchronization sequence repeated N₁ times is in one-to-one correspondence with sequence elements in the pseudo-random sequence; or
the first synchronization sequence repeated N₁ times comprises Y₁ first partial sequences, and the first sequence group is acquired by multiplying the Y₁ first partial sequences by a pseudo-random sequence, wherein the Y₁ first partial sequences are in one-to-one correspondence with sequence elements in the pseudo-random sequence, and Y₁ is greater than or equal to (N₁+1); or
the first synchronization sequence repeated N₁ times comprises Z₁ first partial sequence groups, and the first sequence group is acquired by multiplying the Z₁ first partial sequence groups by a pseudo-random sequence, wherein the Z₁ first partial sequence groups are in one-to-one correspondence with sequence elements in the pseudo-random sequence, each of the Z₁ first partial sequence groups comprises at least one first partial sequence, and Z₁ is greater than or equal to (N₁+1).

7. The method according to claim 1, wherein the at least one sequence group comprises a second sequence group and a third sequence group; wherein
the second sequence group is formed based on a second synchronization sequence or based on a second synchronization sequence repeated N₂ times, N₂ being an integer greater than or equal to 1; and
the third sequence group is formed based on a third synchronization sequence repeated N₃ times, N₃ being an integer greater than or equal to 1.

8. The method according to claim 7, wherein
the second sequence group is acquired by performing randomization on the second synchronization sequence or the second synchronization sequence repeated N₂ times; and
the third sequence group is acquired by performing randomization on the third synchronization sequence repeated N₃ times.

9. The method according to claim 8, wherein
the second synchronization sequence comprises at least one second partial sequence, and the second sequence group is acquired by multiplying the at least one second partial sequence by a pseudo-random sequence, wherein the at least one second partial sequence is in one-to-one correspondence with sequence elements in the pseudo-random sequence; or
the second synchronization sequence comprises at least one second partial sequence group, and the second sequence group is acquired by multiplying the at least one second partial sequence group by a pseudo-random sequence, wherein the at least one second partial sequence group is in one-to-one correspondence with sequence elements in the pseudo-random sequence, and each of the at least one second partial sequence group comprises at least one second partial sequence; or
the second sequence group is acquired by multiplying the second synchronization sequence repeated N₂ times by a pseudo-random sequence, wherein the second synchronization sequence repeated N₂ times is in one-to-one correspondence with sequence elements in the pseudo-random sequence; or
the second synchronization sequence repeated N₂ times comprises Y₂ second partial sequences, and the second sequence group is acquired by multiplying the Y₂ second partial sequences by a pseudo-random sequence, wherein the Y₂ second partial sequences are in one-to-one correspondence with sequence elements in the pseudo-random sequence, and Y₂ is greater than or equal to (N₂+1); or
the second synchronization sequence repeated N₂ times comprises Z₂ second partial sequence groups, and the second sequence group is acquired by multiplying the Z₂ second partial sequence groups by a pseudo-random sequence, wherein the Z₂ second partial sequence groups are in one-to-one correspondence with sequence elements in the pseudo-random sequence, each of the Z₂ second partial sequence groups comprises at least one second partial sequence, and Z₂ is greater than or equal to (N₂+1).

10. The method according to claim 8, wherein
the third sequence group is acquired by multiplying the third synchronization sequence repeated N₃ times by a pseudo-random sequence, wherein the third synchronization sequence repeated N₃ times is in one-to-one correspondence with sequence elements in the pseudo-random sequence; or
the third synchronization sequence repeated N₃ times comprises Y₃ third partial sequences, and the third sequence group is acquired by multiplying the Y₃ third partial sequences by a pseudo-random sequence, wherein the Y₃ third partial sequences are in one-to-one correspondence with sequence elements in the pseudo-random sequence, and Y₃ is greater than or equal to (N₃+1); or
the third synchronization sequence repeated N₃ times comprises Z₃ third partial sequence groups, and the third sequence group is acquired by multiplying the Z₃ third partial sequence groups by a pseudo-random sequence, wherein the Z₃ third partial sequence groups are in one-to-one correspondence with sequence elements in the pseudo-random sequence, each of the Z₃ third partial sequence groups comprises at least one third partial sequence, and Z₃ is greater than or equal to (N₃+1).

11. The method according to claim 1, wherein parameters of the reference signal satisfy at least one of following conditions:
being associated with an operating frequency band of the zero-power device;
being associated with a subcarrier spacing; or
being defined by a communication protocol;
wherein the parameters of the reference signal comprise at least one of a length of the synchronization sequence, a value of N, or a length of each time-domain unit corresponding to the synchronization sequence.

12. A communication method for synchronization, applicable to zero-power communication and performed by a zero-power device, the method comprising:
receiving a reference signal, wherein the reference signal is used for time-domain synchronization and frequency-domain synchronization of the zero-power device, and the reference signal comprises at least one sequence group, wherein the at least one sequence group is formed based on a synchronization sequence repeated N times, N being an integer greater than or equal to 1.

13. The method according to claim 12, wherein the at least one sequence group corresponds to at least one bit, wherein each of the at least one bit corresponds to at least one time-domain unit or at least one sampling point.

14. The method according to claim 12, wherein the at least one sequence group is formed based on at least one of:
a synchronization sequence corresponding to at least one time-domain unit;
a synchronization sequence corresponding to at least one sampling point; or
a synchronization sequence corresponding to a portion of one of the at least one time-domain unit.

15. The method according to claim 12, wherein the at least one sequence group comprises a first sequence group, wherein the first sequence group is formed based on a first synchronization sequence repeated N₁ times, N₁ being an integer greater than or equal to 1.

16. The method according to claim 15, wherein the first sequence group is acquired by performing randomization processing on the first synchronization sequence repeated N₁ times.

17. The method according to claim 16, wherein
the first sequence group is acquired by multiplying the first synchronization sequence repeated N₁ times by a pseudo-random sequence, wherein the first synchronization sequence repeated N₁ times is in one-to-one correspondence with sequence elements in the pseudo-random sequence; or
the first synchronization sequence repeated N₁ times comprises Y₁ first partial sequences, and the first sequence group is acquired by multiplying the Y₁ first partial sequences by a pseudo-random sequence, wherein the Y₁ first partial sequences are in one-to-one correspondence with sequence elements in the pseudo-random sequence, and Y₁ is greater than or equal to (N₁+1); or
the first synchronization sequence repeated N₁ times comprises Z₁ first partial sequence groups, and the first sequence group is acquired by multiplying the Z₁ first partial sequence groups by a pseudo-random sequence, wherein the Z₁ first partial sequence groups are in one-to-one correspondence with sequence elements in the pseudo-random sequence, each of the Z₁ first partial sequence groups comprises at least one first partial sequence, and Z₁ is greater than or equal to (N₁+1).

18. The method according to claim 12, wherein the at least one sequence group comprises a second sequence group and a third sequence group; wherein
the second sequence group is formed based on a second synchronization sequence or based on a second synchronization sequence repeated N₂ times, N₂ being an integer greater than or equal to 1; and
the third sequence group is formed based on a third synchronization sequence repeated N₃ times, N₃ being an integer greater than or equal to 1.

19. The method according to claim 18, wherein
the second sequence group is acquired by performing randomization processing on the second synchronization sequence or the second synchronization sequence repeated N₂ times; and
the third sequence group is acquired by performing randomization processing on the third synchronization sequence repeated N₃ times.

20. A network device, comprising:
a processor;
a transmitter connected to the processor; and
a memory, configured to store one or more executable instructions of the processor,
wherein the transmitter is configured to transmit a reference signal, wherein the reference signal is used for time-domain synchronization and frequency-domain synchronization of a zero-power device, and the reference signal comprises at least one sequence group, wherein the at least one sequence group is formed based on a synchronization sequence repeated N times, N being an integer greater than or equal to 1.
